(19) United States
(12) Patent Application Publication
(10) Pub. No.: US 2011/0308506 A1
(43) Pub. Date: Dec. 22, 2011

(54) INTERNAL COMBUSTION ENGINE CONTROL DEVICE AND CONTROL METHOD THEREOF

(75) Inventors: Go Hayashita, Susono-shi (JP); Keiichiro Aoki, Shizuoka-ken (JP)

(73) Assignee: TOYOTA JIDOSHA KABUSHIKI KAISHA, Toyota-shi (JP)

(21) Appl. No.: 13/164,820

(22) Filed: Jun. 21, 2011

(30) Foreign Application Priority Data
Jun. 22, 2010 (JP) 2010-141794

(51) Int. Cl. F02D 41/00

(52) U.S. Cl. 123/703

(57) ABSTRACT

An internal combustion engine control device and a control method therefore in which feedback control is performed such that a detected air-fuel ratio of exhaust gas detected on the basis of a critical electric current flowing in a solid electrolyte layer of an air-fuel ratio sensor when an air-fuel ratio detection voltage is applied between an exhaust-side electrode layer and an atmosphere-side electrode layer of the sensor matches a stoichiometric air-fuel ratio. When a parameter acquired as an imbalance determination parameter is larger than an imbalance determination threshold, an air-fuel ratio inter-cylinder imbalance state is determined to have occurred. The output responsiveness of the air-fuel ratio sensor when the air-fuel ratio changes from a lean to a rich (or changes in the opposite direction) is acquired, and when this output responsiveness is low, “a sensor responsiveness increasing voltage that is higher than the air-fuel ratio detection voltage” is applied between the exhaust-side electrode layer and the atmosphere-side electrode layer.

### CROSS-REFERENCE TO RELATED APPLICATIONS

This application claims priority to Japanese Patent Application No. 2010-141794 filed on Jun. 22, 2010, which is incorporated herein by reference in its entirety including the specification, drawings and abstract.

### BACKGROUND OF THE INVENTION

1. Field of the Invention

The invention relates to an internal combustion engine control device and a control method thereof that are suitable for a multi-cylinder internal combustion engine and can determine (monitor and detect) an excess increase in non-equilibrium of an air-fuel ratio of the gas mixture (air-fuel ratio inter-cylinder imbalance, air-fuel ratio inter-cylinder variation, unevenness of air-fuel ratio between the cylinders) supplied to the cylinders.

2. Description of the Related Art

An air-fuel ratio control device is available that includes, as shown in FIG. 1, a three-way catalyst (53) disposed in an exhaust passage of an internal combustion engine and an upstream-side air-fuel ratio sensor (67) and a downstream-side air-fuel ratio sensor (68) disposed respectively upstream and downstream of the three-way catalyst (53).

This air-fuel ratio control device calculates an air-fuel ratio feedback amount on the basis of the output value of the upstream-side air-fuel ratio sensor and the output value of the downstream-side air-fuel ratio sensor and performs a feedback control of the air-fuel ratio of the engine by the air-fuel ratio feedback amount so that the air-fuel ratio (air-fuel ratio of the engine) of the gas mixture supplied to the engine matches the stoichiometric air-fuel ratio. An air-fuel ratio is also available that calculates “the air-fuel ratio feedback amount for matching the air-fuel ratio of the engine with the stoichiometric air-fuel ratio” on the basis of only the output value of the upstream-side air-fuel ratio sensor and feedback controls the air-fuel ratio of the engine by the air-fuel ratio feedback amount. The air-fuel ratio feedback amount used in this air-fuel ratio control device is a control amount that is common to all of the cylinders.

However, an internal combustion engine of an electronic fuel injection system typically includes at least one fuel injection valve (39) in each cylinder or an intake port communicating with each cylinder. Therefore, where the characteristic of a fuel injection valve of a certain specific cylinder becomes “a characteristic such that the fuel is injected in an amount exceeding the indicated fuel injection amount”, only the air-fuel ratio of gas mixture supplied to the specific cylinder (air-fuel ratio of the specific cylinder) increases and changes to the rich side. Thus, unevenness of air-fuel ratio between the cylinders (air-fuel ratio inter-cylinder spread, air-fuel ratio inter-cylinder imbalance) increases. In other words, non-equilibrium occurs among the “cylinder air-fuel ratios” which are air-fuel ratios of gas mixtures supplied to the cylinders.

In this case, the average air-fuel ratio of gas mixture supplied to the entire internal combustion engine becomes the air-fuel ratio on the rich side from the stoichiometric air-fuel ratio. Therefore, the air-fuel ratio of the abovementioned specific cylinder is changed to the lean side to bring it close to the stoichiometric air-fuel ratio and at the same time the air-fuel ratio of other cylinders is changed to the lean side to bring it farther from the stoichiometric air-fuel ratio by the air-fuel ratio feedback amount that is common to all of the cylinders. As a result, the average air-fuel ratio of gas mixture supplied to the entire engine is substantially matched with the stoichiometric air-fuel ratio.

However, since the air-fuel ratio of the specific cylinder naturally becomes an air-fuel ratio on the rich side from the stoichiometric air-fuel ratio and the air-fuel ratio of the remaining cylinders becomes an air-fuel ratio on the lean side from the stoichiometric air-fuel ratio, the combustion state of gas mixture in each cylinder differs from the complete combustion state. As a result, the amount of emission discharged from each cylinder (the amount of unburned matter and/or the amount of nitrogen oxides) increases. Therefore, even if the average air-fuel ratio of gas mixture supplied to the engine is the stoichiometric air-fuel ratio, the increase emission is not purified by the three-way catalyst and, as a consequence, the emission can deteriorate.

Therefore, it is important to detect the excessively large unevenness of air-fuel ratio among the cylinders (the occurrence of an air-fuel ratio inter-cylinder imbalance state) and take some measures to prevent the emission from deteriorating. The air-fuel ratio inter-cylinder imbalance can also occur in the case in which the characteristic of the fuel injection valve of specific cylinder is “a characteristic such that the fuel is injected in an amount less than the indicated fuel injection amount”.

One conventional device configured to determine whether or not such an air-fuel ratio inter-cylinder imbalance state has occurred acquires a trajectory length of an output value (output signal) of an air-fuel ratio sensor (the abovementioned upstream-side air-fuel ratio sensor 67) disposed in an exhaust gas collector where exhaust gases from a plurality of cylinders are collected, compares the acquired trajectory length with “a reference value that changes according to the engine revolution speed”, and determines whether or not the air-fuel ratio inter-cylinder imbalance state has occurred on the basis of the comparison result (see, for example, U.S. Pat. No. 7,152,594).

In the present description, the air-fuel ratio inter-cylinder imbalance state (excess air-fuel ratio inter-cylinder imbalance state) means a state in which the difference between the cylinder air-fuel ratios (inter-cylinder air-fuel ratio difference) is equal to or higher than the allowed value, in other words, an air-fuel ratio inter-cylinder imbalance state such that the amount of unburned matter and/or nitrogen oxides exceeds the stipulated value. The determination as to whether the “air-fuel ratio inter-cylinder imbalance state” has occurred is called hereinbelow simply as “air-fuel ratio inter-cylinder imbalance determination or imbalance determination”. Further, the cylinder that has supplied therein the gas mixture with an air-fuel ratio that is different from the air-fuel ratio of gas mixture supplied into the remaining cylinders (for example, substantially stoichiometric air-fuel ratio) will be also referred to hereinbelow as an “imbalance cylinder”. The air-fuel ratio of gas mixture supplied to the imbalance cylinder will be referred to hereinbelow as an “air-fuel ratio of the imbalance cylinder”. The remaining cylinders (cylinder other than the imbalance cylinder) will be referred to hereinbelow as a “normal cylinder” or “non-imbalance cylinder”. The air-fuel ratio of gas mixture supplied to the normal cylinder will be referred to hereinbelow as an “air-fuel ratio of the normal cylinder” or “air-fuel ratio of the non-imbalance cylinder”.

In addition, “the parameter that increases with the increase in the change of the air-fuel ratio of the exhaust gas passing through the location in which the air-fuel ratio sensor is installed” due to the increase in the absolute value of the inter-cylinder air-fuel ratio difference (difference between the air-fuel ratio of the imbalance cylinder and the air-fuel ratio of the normal cylinder), such as the trajectory length of the abovementioned output value of the air-fuel ratio sensor will be also referred to as the “imbalance determination parameter”. This imbalance determination parameter is acquired on the basis of the output value of the air-fuel ratio sensor. The imbalance determination parameter is compared with the imbalance determination threshold to execute the imbalance determination.

It has also been clarified that “the imbalance determination parameter can be acquired on the basis of various values (air-fuel ratio change indication amounts) other than the above-described trajectory length, those values including a differential value d(Vabyfs)/dt of the output value of the air-fuel ratio sensor, a differential value d(abyfs)/dt of the air-fuel ratio (detected air-fuel ratio abyfs) represented by the output value of the air-fuel ratio sensor, a second order differential value d²(Vabyfs)/dt² of the output value of the air-fuel ratio sensor, and a second order differential value d²(byfs)/dt² of the detected air-fuel ratio abyfs.”

More specifically, as shown, for example, in FIG. 2A, the conventional air-fuel ratio sensor includes an air-fuel ratio detection unit including at least “the solid electrolyte layer (671), exhaust-side electrode layer (672), atmosphere-side electrode layer (673), and diffusion resistance layer (674)”. The exhaust-side electrode layer (672) is formed on one surface of the solid electrolyte layer (671). The exhaust-side electrode layer (672) is covered by the diffusion resistance layer (674). The exhaust gas located in the exhaust passage arrives at the outer surface of the diffusion resistance layer (674), passes through the diffusion resistance layer (674), and reaches the exhaust-side electrode layer (672). The atmosphere-side electrode layer (673) is formed on the other surface of the solid electrolyte layer (671). The atmosphere-side electrode layer (673) is exposed to the atmosphere chamber (67A) into which the atmosphere air is introduced.

As shown in FIGS. 2B and 2C, a voltage (air-fuel ratio detection voltage Vp) for generating “a critical current changing according to the air-fuel ratio of exhaust gas” is applied between the exhaust-side electrode layer (672) and the atmosphere-side electrode layer (673). The air-fuel ratio detection voltage is generally applied such that the electric potential of the atmosphere-side electrode layer (673) becomes higher than the electric potential of the exhaust-side electrode layer (672).

As shown in FIG. 2B, when excess oxygen is contained in the exhaust gas that has passed through the diffusion resistance layer (674) and reached the exhaust-side electrode layer (672) (that is when, the air-fuel ratio of the exhaust gas that has reached the exhaust-side electrode layer is leaner than the stoichiometric air-fuel ratio), this oxygen is guided as oxygen ions from the exhaust-side electrode layer (672) to the atmosphere-side electrode layer (673) due to the air-fuel ratio detection voltage and the oxygen pump characteristic of the solid electrolyte layer (671).

By contrast, when excess unburned matter is contained in the exhaust gas that has passed through the diffusion resistance layer (674) and reached the exhaust-side electrode layer (672) (that is when, the air-fuel ratio of the exhaust gas that has reached the exhaust-side electrode layer is richer than the stoichiometric air-fuel ratio), as shown in FIG. 2C, the oxygen contained in the atmosphere chamber (67A) is guided as oxygen ions from the atmosphere-side electrode layer (673) to the exhaust-side electrode layer (672) due to the oxygen cell characteristic of the solid electrolyte layer (671) and reacts with the unburned matter of the exhaust-side electrode layer (672).

Due to the presence of the diffusion resistance layer (674), the transfer amount of oxygen ions is restricted to the value corresponding to the “air-fuel ratio of the exhaust gas that has reached the outer surface of the diffusion resistance layer (674)”. In other words, the electric current generated by the movement of oxygen ions assumes a value corresponding to the air-fuel ratio of exhaust gas (that is, a critical electric current Ip) (see FIG. 3).

The air-fuel ratio sensor outputs the output value Vabyfs corresponding to the “air-fuel ratio of the exhaust gas passing through the location in which the air-fuel ratio sensor is installed” on the basis of this critical current (electric current flowing in the solid electrolyte layer due to the application of the air-fuel ratio detection voltage Vp between the exhaust-side electrode layer and the atmosphere-side electrode layer). This output value Vabyfs is generally converted into the detected air-fuel ratio abyfs on the basis of the “relationship (shown in FIG. 4) between the output value Vabyfs and the air-fuel ratio” that has been determined in advance. As follows from FIG. 4, the output value Vabyfs and the detected air-fuel ratio abyfs are substantially proportional to each other.

Meanwhile, the air-fuel ratio change indication amount, which is “data serving as a base for the imbalance determination parameter”, is not limited to the trajectory length of “the detected air-fuel ratio abyfs or output value Vabyfs of the air-fuel ratio sensor” and may be a value reflecting the state of the change in air-fuel ratio of the exhaust gas passing through the location in which the air-fuel ratio sensor is installed. This feature will be explained below.

In the air-fuel ratio sensor, the exhaust gas from cylinders reaches an ignition sequence (therefore, an exhaust sequence). When an air-fuel ratio inter-cylinder imbalance state has not occurred, the air-fuel ratios of exhaust gas discharged from the cylinders are substantially equal to each other. Therefore, when an air-fuel ratio inter-cylinder imbalance state has not occurred, the waveform of the output value Vabyfs of the air-fuel ratio sensor (in FIG. 5B, the waveform of the detected air-fuel ratio abyfs) is substantially flat, as shown by a broken line C1 in FIG. 5B.

By contrast, when “an air-fuel ratio inter-cylinder imbalance state in which only the air-fuel ratio of a specific cylinder (for example, the first cylinder) has shifted to become richer than the stoichiometric air-fuel ratio (special cylinder rich shift imbalance state)” has occurred, the air-fuel ratio of exhaust gas of the special cylinder becomes significantly different from the air-fuel ratio of exhaust gas from cylinders other than the special cylinder (remaining cylinders).

Therefore, the waveform (in FIG. 5B, the waveform of the detected air-fuel ratio abyfs) of the output value Vabyfs of the air-fuel ratio sensor in the case in which the specific cylinder rich shift imbalance state has occurred changes significantly for each predetermined period, for example, as shown by the solid line C2 in FIG. 5B. This predetermined period is a 720° crank angle in the case of a four-cylinder and four-cycle engine. Thus, the predetermined period corresponds to a crank angle required for each single combustion stroke to be completed in all of the cylinders that discharge the exhaust gas that will reach one air-fuel ratio sensor. In the present description this predetermined period will be also referred to as “unit combustion cycle period”.

Further, as the air-fuel ratio of the imbalance cylinder deviates from the air-fuel ratio of the normal cylinder, the amplitudes of the output value Vabyfs of the air-fuel ratio sensor and the detected air-fuel ratio abyfs increase and the values thereof change more significantly. For example, where the detected air-fuel ratio abyfs obtained when the value of the difference between the air-fuel ratio of the imbalance cylinder and the air-fuel ratio of the non-imbalance cylinder is the first value changes as shown by the solid line C2 in FIG. 5B, the detected air-fuel ratio abyfs obtained when the value of the difference between the air-fuel ratio of the imbalance cylinder and the air-fuel ratio of the non-imbalance cylinder is “the second value that is larger than the first value” changes as shown by a dot-dash line C2a in FIG. 5B.

For this reason, the variation amount of “the output value Vabyfs of the air-fuel ratio sensor or the detected air-fuel ratio abyfs” per unit time (that is, the first differential value of “the output value Vabyfs of the air-fuel ratio sensor or the detected air-fuel ratio abyfs” with respect to time; see values of angles α1, α2 in FIG. 5B) changes little, as shown by a broken line C3 in FIG. 5C, when the inter-cylinder air-fuel ratio difference is small, and changes significantly, as shown by a solid line C4 in FIG. 5C, when the inter-cylinder air-fuel ratio difference is large. Thus, the absolute values of “the differential value d(Vabyfs)/dt and the differential value d(abyfs)/dt” increase with the increase in the degree of air-fuel ratio inter-cylinder imbalance state (as the inter-cylinder air-fuel ratio difference increases).

Therefore, for example, the “maximum value or average value” of the absolute value of “the differential value d(Vabyfs)/dt or the differential value d(abyfs)/dt” a plurality of which are acquired within the unit combustion cycle period can be used as the air-fuel ratio change indication amount.

Further, as shown in FIG. 5D, the variation amount of the variation amount per unit time of the “output value Vabyfs of the air-fuel ratio sensor or detected air-fuel ratio abyfs” practically does not change, as shown by a broken line C5, when the inter-cylinder air-fuel ratio difference is small, but changes significantly, as shown by a solid line C6, as the inter-cylinder air-fuel ratio difference increases.

Therefore, for example, the “maximum value or average value” of the absolute value of the “second order differential value d²(Vabyfs)/dt² or second order differential value d²(byfs)/dt²” a plurality of which are acquired within the unit combustion cycle period can be used as the air-fuel ratio change indication amount.

Further, the air-fuel ratio inter-cylinder imbalance control device uses the value correlated with the above-described air-fuel ratio change indication amount as the imbalance determination parameter, and determines whether or not the air-fuel ratio inter-cylinder imbalance state has occurred by determining whether or not this imbalance determination parameter is larger than a predetermined threshold (imbalance determination threshold).

However, the inventors have discovered that when the air-fuel ratio of exhaust gas changes in an air-fuel ratio region that is very close to the stoichiometric air-fuel ratio (air-fuel ratio region of a predetermined range including the stoichiometric air-fuel ratio; can be also referred to hereinbelow as “stoichiometric air-fuel ratio region”), the air-fuel ratio inter-cylinder imbalance determination sometimes cannot be performed with good accuracy.

This is because when the air-fuel ratio of exhaust gas changes in the stoichiometric air-fuel ratio region, “a state occurs (responsiveness decrease state) in which the output value Vabyfs of the air-fuel ratio sensor does not change with good responsiveness correspondingly to changes in the exhaust gas” and therefore the air-fuel ratio change indication amount cannot represent the “degree of the air-fuel ratio inter-cylinder imbalance state” with sufficient accuracy. In other words, this is because the imbalance determination parameter does not represent with good accuracy the “inter-cylinder air-fuel ratio difference (that is, the difference between the air-fuel ratio of the imbalance cylinder and the air-fuel ratio of the normal cylinder)” when the air-fuel ratio of exhaust gas changes in the stoichiometric air-fuel ratio region.

For example, the air-fuel ratio sensor easily falls into the responsiveness decrease state at the initial stage of use when the air-fuel ratio of exhaust gas changes in the stoichiometric air-fuel ratio region. The following reasons therefore can be considered.

(1) When the air-fuel ratio of exhaust gas changes in the stoichiometric air-fuel ratio region, the air-fuel ratio frequently changes from the “air-fuel ratio that is richer than the stoichiometric air-fuel ratio to the air-fuel ratio that is leaner than the stoichiometric air-fuel ratio and in the opposite direction”. Therefore, the reaction proceeding in the exhaust gas electrode layer should frequently change from the reaction that converts oxygen into oxygen ions to the reaction that converts oxygen ions into oxygen, and in the opposite direction. Therefore, where the reaction rate in the exhaust-side electrode layer is low, the air-fuel ratio sensor falls into the responsiveness decrease state.

(2) When the air-fuel ratio sensor in at the initial stage of use, the reaction rate in the exhaust-side electrode layer can decrease under the effect of impurities that have been admixed to an electrode layer (in particular, the exhaust-side electrode layer) when the air-fuel ratio sensor was manufactured, the effect of electrode layer oxidation, and due to a poor (unfavorable) state of interfaces of the electrode layer, solid electrolyte layer, and exhaust gas.

(3) Further, when the air-fuel ratio sensor includes the catalyst (676), this catalyst (676) does not demonstrate the expected performance, in particular, at the initial stage of use of the air-fuel ratio sensor.

FIG. 6 is a graph illustrating the abovementioned phenomena. The imbalance determination parameter acquired on the basis of the differential value d(abyfs)/dt is plotted against the ordinate in FIG. 6. The usage time of the air-fuel ratio sensor is plotted against the abscissa in FIG. 6. The broken line in FIG. 6 shows the imbalance determination parameter in the case in which the air-fuel ratio inter-cylinder imbalance state has occurred, and the solid line in FIG. 6 shows the imbalance determination parameter in the case in which the air-fuel ratio inter-cylinder imbalance state has not occurred.

As shown by points P1 and P2 in FIG. 6, when the responsiveness of the air-fuel ratio sensor is not good at the initial stage of use, the difference between the imbalance determination parameter in the case in which the air-fuel ratio inter-cylinder imbalance state has occurred and the imbalance determination parameter in the case in which the air-fuel ratio inter-cylinder imbalance state has not occurred decreases. Therefore, an error can occur when determining whether or not the air-fuel ratio inter-cylinder imbalance state has occurred.

By contrast, as shown by points P3 and P4, after the air-fuel ratio sensor has been used for a certain time, the difference between the imbalance determination parameter in the case in which the air-fuel ratio inter-cylinder imbalance state has occurred and the imbalance determination parameter in the case in which the air-fuel ratio inter-cylinder imbalance state has not occurred increases due, for example, to the increase in reaction rate in the exhaust-side electrode layer. Therefore, whether the air-fuel ratio inter-cylinder imbalance state has occurred can be determined with good accuracy.

The output responsiveness of air-fuel ratio sensors is available to increase when “a voltage (sensor responsiveness increasing voltage) that is greater than the voltage applied when the air-fuel ratio is detected (air-fuel ratio detection voltage)” is applied between the exhaust-side electrode layer and the atmosphere-side electrode layer. Thus, the application of the sensor responsiveness increasing voltage demonstrates the same effect as the increase in the usage time of the air-fuel ratio sensor on the output responsiveness of the air-fuel ratio sensor. The increase in the output responsiveness of the air-fuel ratio sensor caused by the application of the sensor responsiveness increasing voltage can be attributed for example to the separation of oxygen contained in the oxides in the exhaust-side electrode layer (that is, reduction of oxide). However, even when the imbalance determination parameter with good responsiveness of the air-fuel ratio sensor and good accuracy can be acquired, such application of the sensor responsiveness increasing voltage results in unnecessary consumption of power and can conversely cause the deterioration of the air-fuel ratio sensor.

### SUMMARY OF INVENTION

With the foregoing in view, it is an object of the invention to provide a control device for an internal combustion engine and a control method therefore that can improve the output responsiveness of the air-fuel ratio sensor and perform accurate determination of air-fuel ratio inter-cylinder imbalance, while avoiding the unnecessary consumption of power.

One aspect of the invention resides in an internal combustion engine control device that is used in a multicylinder internal combustion engine and includes an air-fuel ratio sensor, an air-fuel ratio detection voltage application device, a plurality of fuel injection valves, an air-fuel ratio feedback control device, an imbalance determination device, a responsiveness determination device, and a responsiveness increasing processing execution device.

The air-fuel ratio sensor is installed in an “exhaust collector” or a “location downstream of the exhaust collector in an exhaust passage”. The air-fuel ratio sensor includes an air-fuel ratio detection unit having at least a solid electrolyte layer, an exhaust-side electrode layer formed on one surface of the solid electrolyte layer, a diffusion resistance layer that covers the exhaust-side electrode layer and is reached by the exhaust gas, and an atmosphere-side electrode layer that is formed on the other surface of the solid electrolyte layer and exposed inside an atmosphere chamber.

The air-fuel ratio sensor outputs an output value corresponding to an air-fuel ratio of the exhaust gas passing through the location in which the air-fuel ratio sensor is installed, on the basis of a critical electric current flowing in the solid electrolyte layer, when an air-fuel ratio detection voltage is applied by the air-fuel ratio detection voltage application device.

The fuel injection valves are installed correspondingly to the plurality of cylinders.

The air-fuel ratio feedback control device feedback controls a fuel injection amount injected from the fuel injection valves so that an air-fuel ratio represented by the “output value of the air-fuel ratio sensor when the air-fuel ratio detection voltage is applied between the exhaust-side electrode layer and the atmosphere-side electrode layer” matches a target air-fuel ratio (substantially) set to a stoichiometric air-fuel ratio.

The imbalance determination device acquires, on the basis of the output value of the air-fuel ratio sensor, an imbalance determination parameter that increases with the increase in a “change of the air-fuel ratio of the exhaust gas passing through the location in which the air-fuel ratio sensor is installed” within a period in which the feedback control is executed. Further, the imbalance determination device determines that an air-fuel ratio inter-cylinder imbalance state has occurred when the imbalance determination parameter is greater than a predetermined imbalance determination threshold.

Thus, the imbalance determination parameter is acquired on the basis of the output value of the air-fuel ratio sensor in the course of feedback control of the air-fuel ratio. Thus, the imbalance determination parameter is acquired under circumstances in which the air-fuel ratio of the exhaust gas passing through the location in which the air-fuel ratio sensor is installed changes in a stoichiometric air-fuel ratio region. Therefore, when the output responsiveness of the air-fuel ratio sensor is low, the imbalance determination parameter cannot represent a “level of air-fuel ratio inter-cylinder imbalance state” with sufficient accuracy.

Accordingly, the responsiveness determination device acquires, on the basis of the output value of the air-fuel ratio sensor, a “value corresponding to a variation rate of the output value of the air-fuel ratio sensor (that is, responsiveness indication value)” when the air-fuel ratio of the exhaust gas passing through the location in which the air-fuel ratio sensor is installed changes so as to cross the stoichiometric air-fuel ratio. Then, the responsiveness determination device determines whether an output responsiveness of the air-fuel ratio sensor is less than an allowed responsiveness by comparing the responsiveness indication value with a predetermined threshold.

The responsiveness increasing processing execution device executes a responsiveness increasing processing for raising the output responsiveness of the air-fuel ratio sensor when the “output responsiveness of the air-fuel ratio sensor is determined to be less than the allowed responsiveness” by the responsiveness determination device. More specifically, the responsiveness increasing processing execution device applies a “sensor responsiveness increasing voltage that is higher than the air-fuel ratio detection voltage” between the exhaust-side electrode layer and the atmosphere-side electrode layer so that the electric potential of the atmosphere-side electrode layer becomes higher than the electric potential of the exhaust-side electrode layer.

As a result of the execution of the responsiveness increasing processing, the oxide in the exhaust-side electrode layer is reduced or the state of the interfaces of the exhaust-side electrode layer, solid electrolyte layer, and exhaust gas changes to “a state in which the reaction in the exhaust-side electrode layer is activated”. Therefore, the output responsiveness of the air-fuel ratio sensor is increased. As a result, the imbalance determination parameter assumes a value that accurately represents “the degree of the air-fuel ratio inter-cylinder imbalance state”. Therefore, the imbalance determination can be performed with good accuracy.

Further, the responsiveness increasing processing is executed when the output responsiveness of the air-fuel ratio sensor is less than the allowed responsiveness and is not executed when the output responsiveness of the air-fuel ratio sensor is equal to or higher than the allowed responsiveness. As a result, it is possible to avoid unnecessary power consumption and/or deterioration of the air-fuel ratio sensor.

The responsiveness indication value may be based on a time (first response time) until “the air-fuel ratio represented by the output value of the air-fuel ratio sensor” changes from “a second lean air-fuel ratio, which is higher than the stoichiometric air-fuel ratio and lower than a first lean air-fuel ratio, which is higher than the stoichiometric air-fuel ratio” to “a second rich air-fuel ratio, which is lower than the stoichiometric air-fuel ratio and higher than a first rich air-fuel ratio, which is lower than the stoichiometric air-fuel ratio”, in the case in which “the air-fuel ratio of the exhaust gas passing through the location in which the air-fuel ratio sensor is installed” changes from the “first lean air-fuel ratio” to “the first rich air-fuel ratio”.

The responsiveness indication value may be also based on a time (second response time) until “the air-fuel ratio represented by the output value of the air-fuel ratio sensor” changes from “a fourth rich air-fuel ratio, which is lower than the stoichiometric air-fuel ratio and higher than a third rich air-fuel ratio, which is lower than the stoichiometric air-fuel ratio” to “a fourth lean air-fuel ratio, which is higher than the stoichiometric air-fuel ratio and lower than a third lean air-fuel ratio which is higher than the stoichiometric air-fuel ratio” in the case in which “the air-fuel ratio of the exhaust gas passing through the location in which the air-fuel ratio sensor is installed” changes from “the third rich air-fuel ratio” to “the third lean air-fuel ratio”.

The responsiveness indication value may be a value obtained on the basis of the first response time and the second response time (for example, an average value of the first response time and the second response time).

In addition, it is preferred that the responsiveness increasing processing execution be executed after stopping engine operation. In this case, the fuel injection amount injected from the fuel injection valves may be controlled before stopping engine operation so that “the air-fuel ratio of the exhaust gas present in the location in which the air-fuel ratio sensor is installed” becomes less than the stoichiometric air-fuel ratio. As a result, when the sensor responsiveness increasing voltage is applied, oxygen contained in the oxide of the exhaust-gas electrode layer reacts with a large amount of unburned matter and therefore can be removed more efficiently.

Further, the responsiveness increasing processing may include supplying electric power to a heater of the air-fuel ratio sensor such that the temperature of the solid electrolyte layer after the engine has been stopped becomes higher than the temperature of the solid electrolyte layer in the course of engine operation. This allows the oxide of the exhaust-gas electrode layer to be removed even more efficiently.

Another aspect of the invention resides in the following control method performed in the abovementioned internal combustion engine control device, the method including:

acquiring, on the basis of the output value of the air-fuel ratio sensor, an imbalance determination parameter that increases with the increase in a change of the air-fuel ratio of the exhaust gas passing through the location in which the air-fuel ratio sensor is installed within a period in which the feedback control is executed, and determining that an air-fuel ratio inter-cylinder imbalance state has occurred when the imbalance determination parameter is greater than a predetermined imbalance determination threshold;

acquiring, on the basis of the output value of the air-fuel ratio sensor, a responsiveness indication value corresponding to a variation rate of the output value of the air-fuel ratio sensor when the air-fuel ratio of the exhaust gas passing through the location in which the air-fuel ratio sensor is installed changes so as to cross the stoichiometric air-fuel ratio, and determining whether an output responsiveness of the air-fuel ratio sensor is less than an allowed responsiveness by comparing the responsiveness indication value with a predetermined threshold; and

executing a responsiveness increasing processing for raising the output responsiveness of the air-fuel ratio sensor by applying a sensor responsiveness increasing voltage that is higher than the air-fuel ratio detection voltage between the exhaust-side electrode layer and the atmosphere-side electrode layer so that the electric potential of the atmosphere-side electrode layer becomes higher than the electric potential of the exhaust-side electrode layer when the output responsiveness of the air-fuel ratio sensor is determined by the responsiveness determination device to be less than the allowed responsiveness.

Details of the features and additional advantages of the present internal combustion engine control device and the control method thereof can be easily understood from the following description of embodiments illustrated by the accompanying drawings.

### BRIEF DESCRIPTION OF DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic plan view of the internal combustion engine obtained by using the internal combustion engine control device of the embodiment of the invention in the conventional internal combustion engine control device;

FIGS. 2A to 2C are schematic cross-sectional views of the air-fuel ratio detection unit provided in the air-fuel ratio sensor (upstream-side air-fuel ratio sensor) shown in FIG. 1;

FIG. 3 is a graph illustrating the relationship between the air-fuel ratio of exhaust gas and the critical current value of the air-fuel ratio sensor;

FIG. 4 is a graph illustrating the relationship between the air-fuel ratio of exhaust gas and the output value of the air-fuel ratio sensor;

FIGS. 5A to 5D are time charts illustrating the behavior of values related to the imbalance determination parameter in the case in which an air-fuel ratio inter-cylinder imbalance state has occurred and in the case in which such state has not occurred;

FIG. 6 is a graph illustrating the relationship between the usage time of the air-fuel ratio sensor and the imbalance determination parameter;

FIG. 7 is a cross-sectional view of the internal combustion engine that illustrates a configuration of the engine using the internal combustion engine control device according to the embodiment of the invention;

FIG. 8 is a partial schematic perspective view (transparent view) of the air-fuel ratio sensor (upstream-side air-fuel ratio sensor) shown in FIGS. 1 and 7;

FIG. 9 is a partial cross-sectional view of the air-fuel ratio sensor shown in FIGS. 1 and 7;

FIG. 10 is a graph showing the relationship between the air-fuel ratio of exhaust gas and the output value of the downstream-side air-fuel ratio sensor shown in FIGS. 1 and 7;

FIG. 11 is a time chart illustrating the behavior of various values when the responsiveness indication value is acquired;

FIG. 12 is a time chart illustrating the behavior of various values when the responsiveness increasing processing is executed;

FIG. 13 is a flowchart illustrating a routine executed by a central processing unit (CPU) shown in FIG. 7;

FIG. 14 is a flowchart illustrating a routine executed by the CPU shown in FIG. 7;

FIG. 15 is a flowchart illustrating a routine executed by the CPU shown in FIG. 7;

FIG. 16 is a flowchart illustrating a routine executed by the CPU shown in FIG. 7;

FIG. 17 is a flowchart illustrating a routine executed by the CPU shown in FIG. 7;

FIG. 18 is a flowchart illustrating a routine executed by the CPU shown in FIG. 7;

FIG. 19 is a flowchart illustrating a routine executed by the CPU shown in FIG. 7; and

FIG. 20 is a flowchart illustrating a routine executed by the CPU shown in FIG. 7.

### DETAILED DESCRIPTION OF EMBODIMENTS

A control device for an internal combustion engine according to embodiments of the invention (will be also referred to hereinbelow simply as “control device”) and a control method thereof will be described below with reference to the appended drawings. The control device is an “air-fuel ratio control device” that controls an air-fuel ratio of a gas mixture supplied to an internal combustion engine (air-fuel ratio of engine). This control device is also an “inter-cylinder air-fuel ratio imbalance determination device” that determines whether or not an inter-cylinder air-fuel ratio imbalance has occurred.

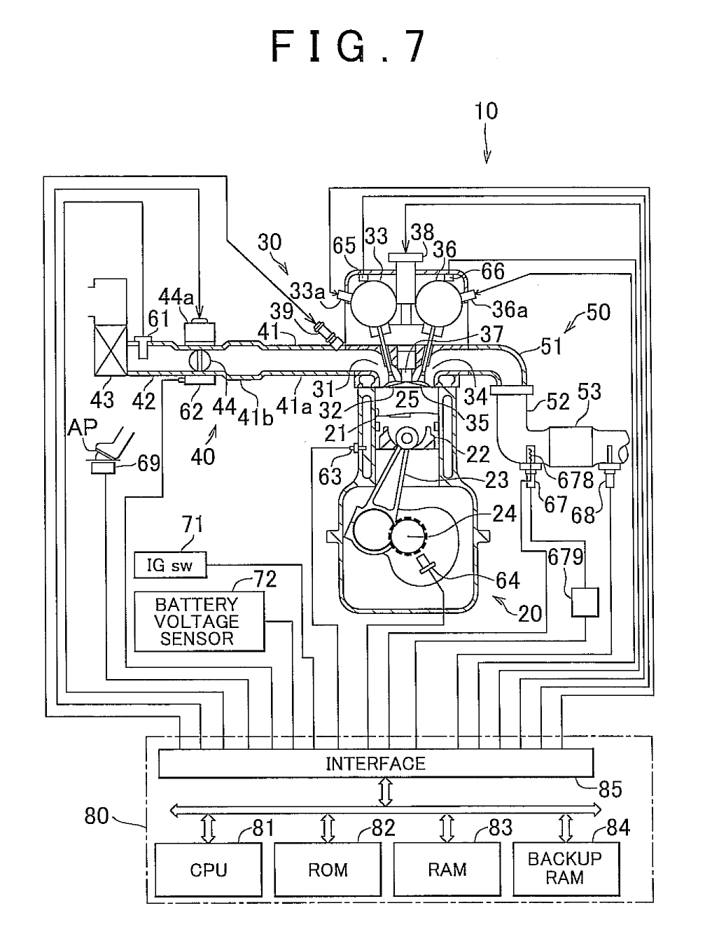

FIG. 7 shows a schematic configuration of a system in which the control device is applied to a four-cycle, spark-ignited, multi-cylinder (in-line four cylinders) internal combustion engine 10. FIG. 7 shows only the cross section of a specific cylinder, but a similar configuration is provided in the other cylinders.

The internal combustion engine 10 includes a cylinder block unit 20 including a cylinder block, a cylinder block lower case, and an oil pan, a cylinder head unit 30 fixed on top of the cylinder block unit 20, an intake system 40 serving to supply a gasoline gas mixture to the cylinder block unit 20, and an exhaust system 50 for releasing exhaust gas from the cylinder block unit 20 to the outside.

The cylinder block unit 20 includes a cylinder 21, a piston 22, a connecting rod 23, and a crankshaft 24. The piston 22 reciprocates inside the cylinder 21, the reciprocating movement of the piston 22 is transmitted to the crankshaft 24 via the connecting rod 23, and the crankshaft 24 is thereby rotated. The wall surface of the cylinder 21 and the upper surface of the piston 22 together with the lower surface of the cylinder head unit 30 form a combustion chamber 25.

The cylinder head unit 30 is provided with an intake port 31 communicating with the combustion chamber 25, an intake valve 32 that opens and closes the intake port 31, a variable intake timing control device 33 that includes an intake cam shaft driving the intake valve 32 and continuously changes a phase angle of the intake cam shaft, an actuator 33a of the variable intake timing control device 33, an exhaust port 34 communicating with the combustion chamber 25, an exhaust valve 35 that opens and closes the exhaust port 34, a variable exhaust timing control device 36 that includes an exhaust cam shaft driving the exhaust valve 35 and continuously changes a phase angle of the exhaust cam shaft, an actuator 36a of the variable exhaust timing control device 36, a sparkplug 37, an igniter 38 including an ignition coil that generates a high voltage to be applied to the spark plug 37, and a fuel injection valve (fuel injection device, fuel supply device) 39.

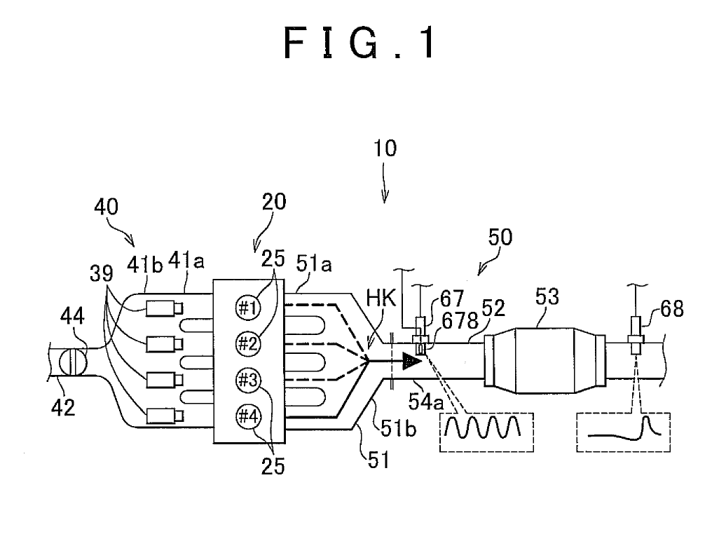

As also shown in FIG. 1, one fuel injection valve 39 is installed for each combustion chamber 25. The fuel injection valve 39 is provided in the intake port 31. In the normal state, the fuel injection valve 39 injects “fuel in an indicated fuel injection amount included in a fuel injection instruction signal” into the intake port 31 in response to the fuel injection instruction signal. Thus, each of a plurality of cylinders is provided with the fuel injection valve 39 that performs fuel supply independently of other cylinders.

The intake system 40 includes an intake manifold 41, an intake pipe 42, an air filter 43, and a throttle valve 44.

As shown in FIG. 1, the intake manifold 41 is constituted by a plurality of branches 41a and a surge tank 41b. One end of each of the plurality of branches 41a is connected to a respective intake port 31 from among the plurality of intake ports, as shown in FIG. 7. The other ends of the plurality of branches 41a are connected to the surge tank 41b. One end of the intake pipe 42 is connected to the surge tank 41b. The air filter 43 is installed at the other end of the intake pipe 42. The throttle valve 44 is located inside the intake pipe 42 and serves to change the opening cross-section area of the intake passage. The throttle valve 44 is rotationally driven inside the intake pipe 42 by a throttle valve actuator 44a (part of the throttle valve drive device) constituted by a DC motor.

The exhaust system 50 is provided with an exhaust manifold 51, an exhaust pipe 52, an upstream-side catalyst 53 disposed in the exhaust pipe 52, and a downstream-side catalyst (not shown in the figure) disposed in the exhaust pipe 52 downstream of the upstream-side catalyst 53.

As shown in FIG. 1, the exhaust manifold 51 includes a plurality of branches 51a, each branch being connected at one end thereof to the exhaust port, and a collector 51b in which all of the branches 51a are collected at the other ends of the plurality of branches 51a. The exhaust gas from a plurality of cylinders (two or more, four in the example) is collected in the collector 51b and this is why the collector is also called an exhaust collector HK. The exhaust pipe 52 is connected to the collector 51b. As shown in FIG. 7, the exhaust port 34, exhaust manifold 51, and exhaust pipe 52 constitute an exhaust passage.

The upstream-side catalyst 53 and the downstream-side catalyst are both the so-called three-way catalytic devices (exhaust purification catalysts) supporting an active component including a noble metal (catalytic substance) such as platinum, rhodium and palladium. Each catalyst has a function of oxidizing unburned components such as HC, CO, and H₂ and reducing nitrogen oxides (NOx) when the air-fuel ratio of the gas flowing into the catalyst is a stoichiometric air-fuel ratio. This function is also called a catalytic function. Each catalyst also has an oxygen absorption function of absorbing (storing) oxygen, and this oxygen absorption function makes it possible to remove unburned components and nitrogen oxides even when the air-fuel ratio shifts from the stoichiometric air-fuel ratio. This function is realized by an oxygen-storing material, such as ceria (CeO₂), supported by the catalyst.

This system includes a heat-ray air flowmeter 61, a throttle position sensor 62, a liquid temperature sensor 63, a crank position sensor 64, an intake cam position sensor 65, an exhaust cam position sensor 66, an upstream-side air-fuel ratio sensor 67, a downstream-side air-fuel ratio sensor 68, an accelerator depression amount sensor 69, an ignition key switch 71, and a battery voltage sensor 72.

The air flowmeter 61 outputs a signal corresponding to a mass flow rate Ga of intake air flowing inside the intake pipe 42. Thus, the intake air amount Ga represents the amount of air taken into the engine 10 per unit time. The throttle position sensor 62 detects and opening degree (throttle opening degree) of the throttle valve 44 and outputs a signal representing a throttle valve opening degree TA. The liquid temperature sensor 63 detects the temperature of cooling liquid of the internal combustion engine 10 and outputs a signal representing the cooling liquid temperature THW.

The crank position sensor 64 outputs a signal having a narrow pulse width each time the crankshaft 24 rotates through 10° and a signal having a wide pulse width each time each time the crankshaft 24 rotates through 360°. This signal is converted into the engine revolution speed NE by the below-described electric control device 80.

The intake cam position sensor 65 outputs one pulse each time the intake cam shaft rotates through 90°, then 90°, and further 180° from a predetermined angle. The below-described electric control device 80 acquires an absolute crank angle CA determined with reference to a compression upper dead center of a reference cylinder (for example, the first cylinder) on the basis of signals from the crank position sensor 64 and the intake cam position sensor 65. This absolute crank angle CA is set to a “0° crank angle” in the compression upper dead center of the reference cylinder, increases to a 720° crank angle according to the rotation angle of the crankshaft, and is set again to the 0° crank angle at this point in time.

The exhaust cam position sensor 66 outputs one pulse each time the exhaust cam shaft rotates through 90°, then 90°, and further 180° from a predetermined angle.

As also shown in FIG. 1, the upstream-side air-fuel ratio sensor 67 (air-fuel sensor in accordance with the invention) is disposed in “either of the exhaust manifold 51 and the exhaust pipe 52 (that is, exhaust passage)” at the position between the collector 51b of the exhaust manifold 51 (exhaust collector HK) and the upstream-side catalyst 53. The upstream-side air-fuel ratio sensor 67 is the “wide-band air-fuel sensor of a critical current system that is provided with a diffusion resistance layer” that is disclosed, for example, in Japanese Patent Application Publication No. 11-72473 (JP-A-11-72473), Japanese Patent Application Publication No. 2000-65782 (JP-A-2000-65782), and Japanese Patent Application Publication No. 2004-69547 (JP-A-2004-69547).

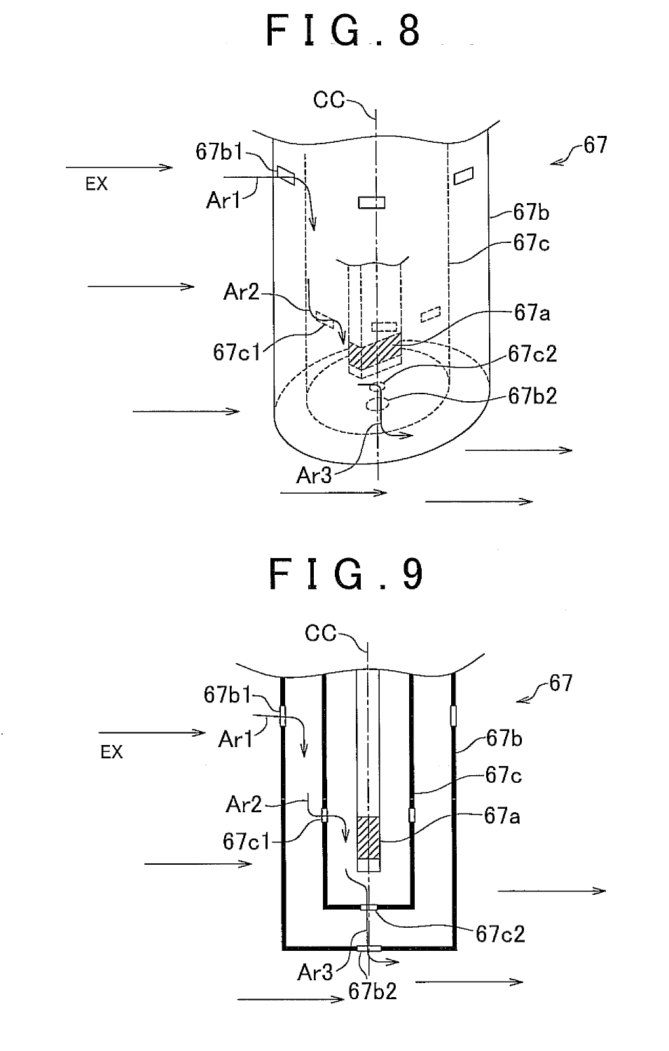

As shown in FIGS. 8 and 9, the upstream-side air-fuel ratio sensor 67 has an air-fuel ratio detection unit 67a, an outer protective cover 67b, and an inner protective cover 67c.

The outer protective cover 67b is a hollow cylindrical body made of a metal. The outer protective cover 67b accommodates inside thereof the inner protective cover 67c so as to cover the inner protective cover 67c. A plurality of inflow holes 67b1 are provided in the side surface of the outer protective cover 67b. The inflow holes 67b1 are through holes for causing the exhaust gas EX (exhaust gas outside the outer protective cover 67b) flowing in the exhaust passage to flow into the outer protective cover 67b. The outer protective cover 67b has in the bottom surface thereof an outflow hole 67b2 for causing the exhaust gas located inside the outer protective cover 67b to flow to the outside (exhaust passage).

The inner protective cover 67c is a hollow cylindrical body made from a metal and having a diameter less than that of the outer protective cover 67b. The inner protective cover 67c accommodates inside thereof the air-fuel ratio detection unit 67a so as to cover the air-fuel ratio detection unit 67a. A plurality of inflow holes 67c1 are provided in the side surface of the inner protective cover 67c. The inflow holes 67c1 are through holes for causing the exhaust gas that has flown into the “space between the outer protective cover 67b and the inner protective cover 67c” through the inflow holes 67b1 of the outer protective cover 67b to flow into the inner protective cover 67c. Further, the inner protective cover 67c has in the bottom surface thereof an outflow hole 67c2 for causing the exhaust gas located inside the inner protective cover 67c to flow to the outside.

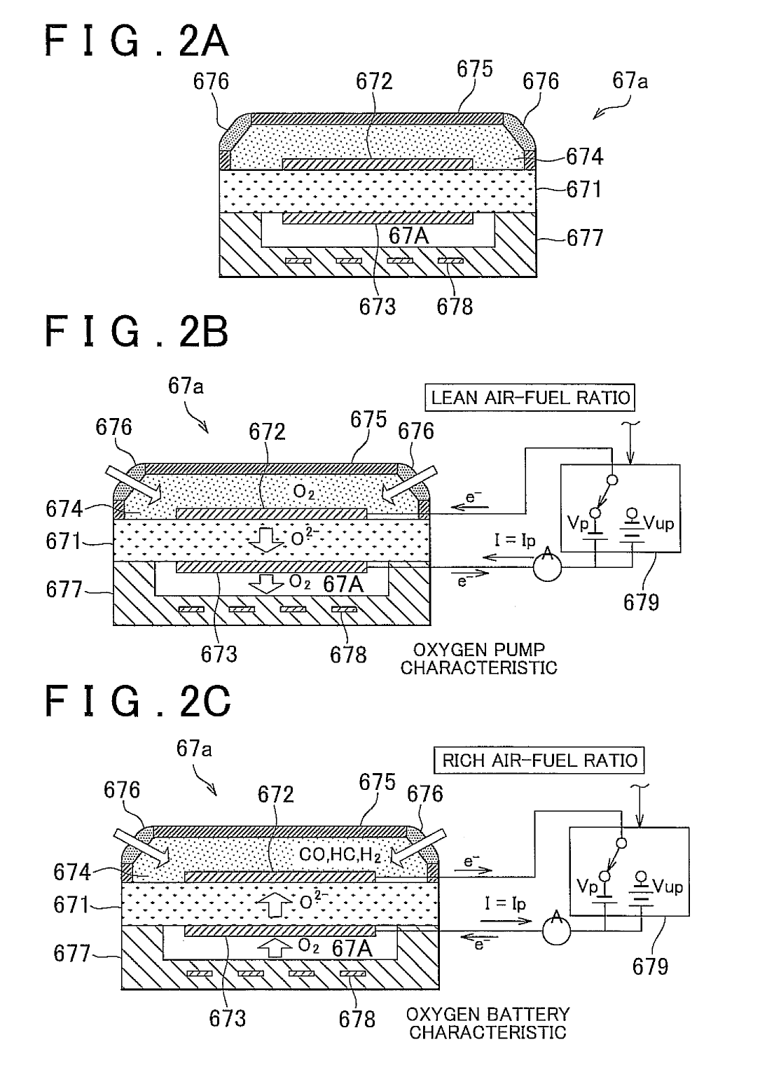

As shown in FIGS. 2A to 2C, the air/flow ratio detection unit 67a includes a solid electrolyte layer 671, an exhaust-side electrode layer 672, an atmosphere-side electrode layer 673, a diffusion resistance layer 674, a first wall portion 675, a catalytic unit 676, a second wall portion 677, and a heater 678.

The solid electrolyte layer 671 is an oxide sintered body having oxygen ion conductivity. In the example, the solid electrolyte layer 671 is a “stabilized zirconia element” which is a solid solution of CaO as a stabilizer in ZrO₂ (zirconia). The solid electrolyte layer 671 demonstrates the conventional “oxygen cell characteristic” and “oxygen pump characteristic” when the temperature thereof becomes equal to or higher than an activation temperature.

The exhaust-side electrode layer 672 is from a noble metal with high catalytic activity such as platinum (Pt) and rhodium (Rh). The exhaust-side electrode layer 672 is formed on one surface of the solid electrolyte layer 671. The exhaust-side electrode layer 672 is formed by chemical plating so as to have sufficient permeability (that is, porous).

The atmosphere-side electrode layer 673 is from a noble metal with high catalytic activity such as platinum (Pt). The atmosphere-side electrode layer 673 is formed on the other surface of the solid electrolyte layer 671, so as to be opposite the exhaust-side electrode layer 672, with the solid electrolyte layer 671 being sandwiched therebetween. The atmosphere-side electrode layer 673 is formed by chemical plating so as to have sufficient permeability (that is, porous).

The diffusion resistance layer (diffusion rage-controlling layer) 674 is constituted by a porous ceramic material (heat-resistant inorganic substance). The diffusion resistance layer 674 is formed, for example, by a plasma spraying method so as to cover the outer surface of the exhaust-side electrode layer 672.

The first wall portion 675 is constituted by a dense and gas-impermeable alumina ceramic. The first wall portion 675 is formed so as to cover the diffusion resistance layer 674, with the exception of a corner (part) of the diffusion resistance layer 674. Thus, the first wall portion 675 is provided with a through portion in which part of the diffusion resistance layer 674 is exposed.

The catalytic unit 676 is formed in the through portion so as to close the through portion of the first wall portion 675. Similarly to the upstream-side catalyst 53, the catalytic unit 676 supports a catalytic substance that enhances the redox reaction and an oxygen storage material that demonstrates an oxygen storing function. The catalytic unit 676 is a porous body. Therefore, as shown by thick white arrows in FIGS. 2B and 2C, the exhaust gas (exhaust gas that has flown into the abovementioned inner protective cover 67c) arrives at the diffusion resistance layer 674 through the catalytic unit 676, and this exhaust gas further passes through the diffusion resistance layer 674 and arrives at the exhaust-side electrode layer 672.

The second wall portion 677 is constituted by a dense and gas-impermeable alumina ceramic. The second wall portion 677 is configured to form an “atmosphere chamber 67A”, which is a space for accommodating the atmosphere-side electrode layer 673. The atmosphere air is introduced in the atmosphere chamber 67A.

A power source (applied voltage regulation device) 679 is connected to the upstream-side air-fuel ratio sensor 67. When the upstream-side air-fuel ratio sensor 67 is required to detect the air-fuel ratio, the power source 679 applies a voltage Vp (for example, 0.4 V) for air-fuel ratio detection, in response to the instruction from the below-described electric control device 80, between the exhaust-side electrode layer 672 and the atmosphere-side electrode layer 673 so that the electric potential of the atmosphere-side electrode layer 673 becomes higher by the voltage Vp than the electric potential of the exhaust-side electrode layer 672. Further, when it is necessary to improve the responsiveness of the upstream-side air-fuel ratio sensor 67, the power source 679 applies a voltage Vup for sensor responsiveness improvement, in response to the instruction from the below-described electric control device 80, between the exhaust-side electrode layer 672 and the atmosphere-side electrode layer 673 so that the electric potential of the atmosphere-side electrode layer 673 becomes higher by the voltage Vup than the electric potential of the exhaust-side electrode layer 672. The voltage Vup for sensor responsiveness improvement is, for example, 2 V and higher than the voltage Vp for air-fuel ratio detection.

The heater 678 is embedded in the second wall portion 677. The heater 678 generates heat when energized by the below-described electric control device 80, heats the solid electrolyte layer 671, exhaust-side electrode layer 672, and atmosphere side electrode layer 673, and regulates the temperature thereof. The “solid electrolyte layer 671, exhaust-side electrode layer 672, and atmosphere side electrode layer 673” heated by the heater 678 are also called “sensor element units or air-fuel ratio sensor elements”. Therefore, the heater 678 controls the “air-fuel ratio sensor element temperature”, which is the temperature of the sensor element unit.

The larger is the excitation amount of the heater 678 (current flowing in the heater 678), the large is the amount of heat generated by the heater 678. The excitation amount of the heater 678 is regulated so as to be increased with the increase in a duty signal (can be also referred to hereinbelow as “heater duty Duty”) outputted by the electric control device 80. The amount of heat generated by the heater 678 is at maximum when the heater duty Duty is 100%. When the heater duty Duty is 0%, the excitation of the heater 678 is terminated. As a result, the heater 678 generates no heat.

The temperature of the air-fuel ratio sensor element changes with the variation in the admittance Y of the solid electrolyte layer 671. In other words, the temperature of the air-fuel ratio sensor element can be estimated on the basis of admittance Y Typically, the temperature of the air-fuel ratio sensor element increases with the increase in admittance Y. The electric control device 80 periodically superimposes “a rectangular or sine voltage” on “the air-fuel ratio detection voltage Vp or sensor responsiveness increasing voltage Vup applied by the power source 679” between the exhaust-side electrode layer 672 and the atmosphere-side electrode layer 673 and acquires the actual admittance Yact of the air-fuel ratio sensor 67 (solid electrolyte layer 671) on the basis of electric current flowing in the solid electrolyte layer 671.

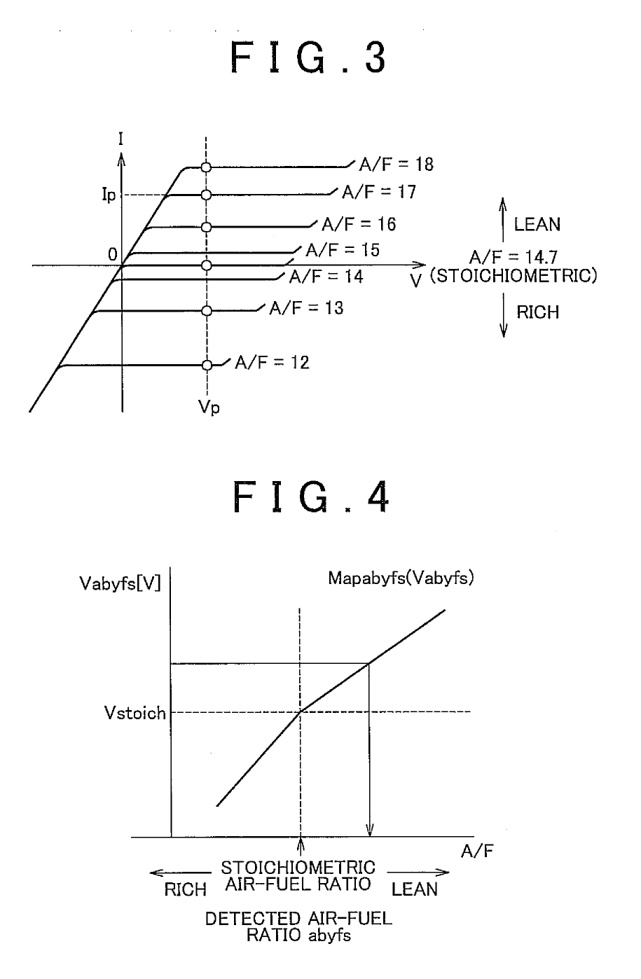

As shown in FIG. 2B, when the air-fuel ratio detection voltage Vp is applied and the air-fuel ratio of exhaust gas is on the lean side with respect to the stoichiometric air-fuel ratio, the upstream-side air-fuel ratio sensor 67 ionizes oxygen that has reached the exhaust-side electrode layer 672 via the diffusion resistance layer 674 and conveys the ions to the atmosphere-side electrode layer 673. As a result, an electric current I flows from the positive electrode to the negative electrode of the power source 679. As shown in FIG. 3, the size of this current I is a constant value proportional to the concentration of oxygen that has reached the exhaust-side electrode layer 672 (partial pressure of oxygen, air-fuel ratio of exhaust gas). The upstream-side air-fuel ratio sensor 67 outputs a value obtained by converting this current (that is, critical current Ip) into voltage as an output value Vabyfs.

As shown in FIG. 2C, when the air-fuel ratio detection voltage Vp is applied and the air-fuel ratio of exhaust gas is on the rich side with respect to the stoichiometric air-fuel ratio, the upstream-side air-fuel ratio sensor 67 ionizes oxygen present in the atmosphere chamber 67A, guides the ions to the exhaust-side electrode layer 672, and oxidizes the unburned matter (HC, CO, and H₂) that reaches the exhaust-side electrode layer 672 via the diffusion resistance layer 674. As a result, the current I flows from the negative electrode to the positive electrode of the power source 679. As shown in FIG. 3, the size of this current I is also a constant value proportional to the concentration of unburned matter (that is, the air-fuel ratio of exhaust gas) that has reached the exhaust-side electrode layer 672. The upstream-side air-fuel ratio sensor 67 outputs a value obtained by converting this current (that is, critical current Ip) into a voltage as the output value Vabyfs.

Thus, as shown in FIG. 4, the air-fuel ratio detection unit 67a outputs as an “air-fuel ratio sensor output” the output value Vabyfs corresponding to the air-fuel ratio (upstream-side air-fuel ratio abyfs, detected air-fuel ratio abyfs) of gas that has flown by the installation position of the upstream-side air-fuel ratio sensor 67 and reached the air-fuel ratio detection unit 67a via the inflow holes 67b1 of the outer protective cover 67b and the inflow holes 67c1 of the inner protective cover 67c. The output value Vabyfs increases with the increase in the air-fuel ratio of gas that has reached the air-fuel ratio detection unit 67a (with the transition or a lean mixture). Thus, the output value Vabyfs is substantially proportional to the air-fuel ratio of gas that has reached the air-fuel ratio detection unit 67a.

The electric control device 80 stores the air-fuel ratio conversion table (map) Mapabyfs shown in FIG. 4 and detects the actual upstream-side air-fuel ratio abyfs (that is, acquires the detected air-fuel ratio abyfs) by applying the output value Vabyfs of the air-fuel ratio sensor 67 to the air-fuel ratio conversion table Mapabyfs.

The upstream-side air-fuel ratio sensor 67 is installed so that the outer protective cover 67b is exposed in either of the exhaust manifold 51 and the exhaust pipe 52 at a position between the exhaust collector HK of the exhaust manifold 51 and the upstream-side catalyst 53.

More specifically, as shown in FIGS. 8 and 9, the air-fuel ratio sensor 67 is installed in the exhaust passage so that the bottom surfaces of the protective covers (67b, 67c) are parallel to the flow of exhaust gas EX, and the central axes CC of the protective covers (67b, 67c) are perpendicular to the flow of exhaust gas EX. As a result, the exhaust gas EX inside the exhaust passage that has reached the inflow hole 67b1 of the outer protective cover 67b is sucked in the interior of the outer protective cover 67b and inner protective cover 67c by the flow of exhaust gas EX in the exhaust passage that flows in the vicinity of the outflow hole 67b2 of the outer protective cover 67b.

Therefore, the exhaust gas EX flowing in the exhaust passage passes through the inflow holes 67b1 of the outer protective cover 67b, as shown by an arrow Ar1 in FIGS. 8 and 9) and flows between the outer protective cover 67b and inner protective cover 67c. This exhaust gas then flows into “the interior of the inner protective cover 67c” through “the inflow holes 67c1 of the inner protective cover 67c”, as shown by an arrow Ar2, and reaches the air-fuel ratio detection unit 67a. Then, the exhaust gas flows out into the exhaust passage through “the outflow hole 67c2 of the inner protective cover 67c and the outflow hole 67b2 of the outer protective cover 67b”, as shown by an arrow Ar3.

Therefore, the flow velocity of exhaust gas inside the “outer protective cover 67b and inner protective cover 67c” changes according to the flow velocity of exhaust gas EX (or the intake air amount Ga per unit time) flowing in the vicinity of the outflow hole 67b2 of the outer protective cover 67b. In other words, the time interval from “a point of time in which exhaust gas (first exhaust gas) with a certain air-fuel ratio reaches the inflow hole 67b1” to “a point of time in which this first exhaust gas reaches the air-fuel ratio detection unit 67a” depends of the intake air amount Ga, but does not depend on the engine revolution speed NE. Therefore, the output responsiveness of the air-fuel ratio sensor 67 to “the air-fuel ratio of exhaust gas flowing in the exhaust passage” improves with the increase in the flow rate (flow velocity) of exhaust gas flowing in the vicinity of the outer protective cover 67b of the air-fuel ratio sensor 67. This conclusion is also valid when the upstream-side air-fuel ratio sensor 67 has only the inner protective cover 67c.

Further, when the sensor responsiveness increasing voltage Vup is applied between the exhaust-side electrode layer 672 and the atmosphere-side electrode layer 673 of the upstream-side air-fuel ratio sensor 67, the metal oxide contained in the exhaust-side electrode layer 672 is reduced to a metal. As a result, the reaction rate of exhaust gas in the exhaust-side electrode layer 672 increases and therefore the output responsiveness of the upstream-side air-fuel ratio sensor 67 in the case in which the air-fuel ratio of exhaust gas changes in the stoichiometric air-fuel ratio region also increases. In this case, where the air-fuel ratio of exhaust gas is richer (less) than the stoichiometric air-fuel ratio (when excess unburned matter is contained in the exhaust gas), the metal oxide contained in the exhaust-side electrode layer 672 is reduced more effectively. In addition, in this state, oxygen that has adhered to the noble metal of the catalyst 676 is consumed and therefore the catalyst 676 demonstrates the function inherent thereto. As a result, the output responsiveness of the upstream-side air-fuel ratio sensor 67 is further improved (restored).

Referring again to FIG. 7, the downstream-side air-fuel ratio sensor 68 is installed in the exhaust pipe 52 downstream of the upstream-side catalyst 53 and upstream of the downstream-side catalyst (that is, in the exhaust passage between the upstream-side catalyst 53 and downstream-side catalyst). The downstream air-fuel ratio sensor 68 is a conventional oxygen concentration sensor of an electromotive force system (conventional oxygen concentration sensor of a concentration cell type using stabilized zirconia). The downstream-side air-fuel ratio sensor 68 generates an output value Voxs corresponding to the air-fuel ratio (that is, the air-fuel ratio of gas flowing out of the upstream-side catalyst 53 and flowing into the downstream-side catalyst and therefore the time-average value of the air-fuel ratio of gas mixture supplied to the engine) of the gas to be detected, which is the gas passing through the location where the downstream-side air-fuel ratio sensor 68 is installed in the exhaust passage.

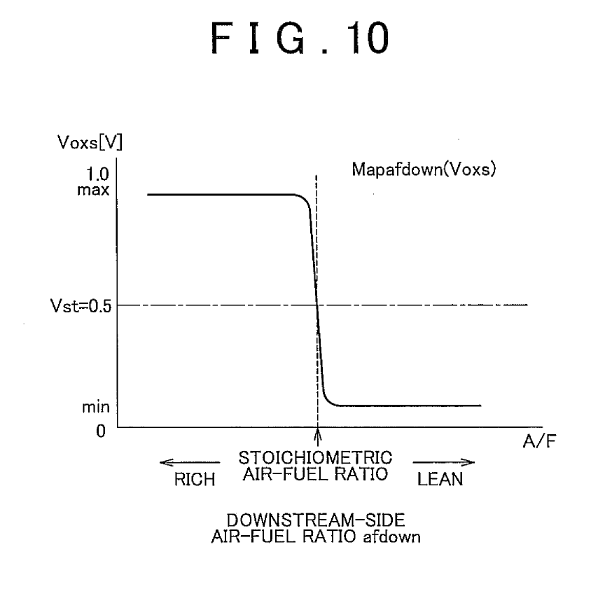

As shown in FIG. 10, this output value Voxs is a maximum output value max (for example, about 0.9 V) when the air-fuel ratio of the gas to be detected is richer than the stoichiometric air-fuel ratio, a minimum output value min (for example, about 0.1 V) when the air-fuel ratio of the gas to be detected is leaner than the stoichiometric air-fuel ratio, and a voltage Vst (intermediate voltage Vst; for example, about 0.5 V) that is substantially between the maximum output voltage max and minimum output voltage min when the air-fuel ratio of the gas to be detected is the stoichiometric air-fuel ratio.

Further, the output value Voxs rapidly changes from the maximum output value max to the minimum output value min when the air-fuel ratio of the gas to be detected changes from the stoichiometric air-fuel ratio to the air-fuel ratio that is leaner than the rich air-fuel ratio and rapidly changes from the minimum output value min to the maximum output value max when the air-fuel ratio of the gas to be detected changes from the stoichiometric air-fuel ratio to the air-fuel ratio that is richer than the lean air-fuel ratio.

The accelerator depression amount sensor 69 shown in FIG. 7 outputs a signal representing an operation amount Accp (accelerator pedal operation amount Accp) of the an accelerator pedal AP operated by the driver. The accelerator pedal operation amount Accp increases with the increase in the depression amount of the accelerator pedal AP (accelerator pedal operation amount).

The ignition key switch 71 is maintained at the ON position when the engine 10 operates and maintained at the OFF position when the operation of the engine 10 is stopped. The battery voltage sensor 72 detects the voltage of a battery (not shown in the figure) of the vehicle where the engine 10 is installed and outputs a signal representing the detected battery voltage VB. The battery serves to supply power also to the heater 678 and power source 679 of the upstream-side air-fuel ratio sensor 67.

The electric control unit 80 is a conventional microcomputer including “a CPU 81, a read-only memory (ROM) 82 in which the program executed by the CPU 81, a table (a map, a function), and constants have been stored in advance, a random access memory (RAM) 83 that stores data temporarily as required by the CPU 81, a backup RAM 84, and an interface 85 including an analog-to-digital (AD) converter”.

The backup RAM 84 receives the supply of power from the battery installed on the vehicle, regardless of the position of the ignition key switch 71 (OFF position, start position, or ON position). The backup RAM 84 stores data (data are written) in response to an instruction from the CPU 81 when power supply is received from the battery and saves (memorizes) the data so as to enable reading thereof. The backup RAM 84 cannot save the data when power supply from the battery is cut off, for example, when the battery is taken off the vehicle. Accordingly, the CPU 81 initializes (sets to the default value) the data that have to be saved in the backup RAM 84 when power supply to the backup RAM 84 is restarted.

The interface 85 is connected to the above-described sensors and supplies the signals from the sensors to the CPU 81. Further, the interface 85 outputs, in response to the instructions from the CPU 81, the drive signals (instruction signals) to the actuator 33a of the variable intake timing control device 33, the actuator 36a of the variable exhaust timing control device 36, the igniter 38 of each cylinder, a fuel injection valve 39 provided for each cylinder, the throttle valve actuator 44a, the heater 678 of the air-fuel ratio sensor 67, and the power source 679.

The electric control unit 80 sends an instruction signal to the throttle vale actuator 44a such that the throttle valve opening degree TA increases with the increase in the acquired operation amount Accp of the accelerator pedal. Thus, the electric control unit 80 provides a throttle valve drive unit that changes the opening degree of “the throttle valve 44 installed in the intake passage of the engine 10” according to the acceleration operation amount (accelerator pedal operation amount Accp) of the engine 10 that is changed by the driver.

(Summary of Control)

The control realized by the control device is summarized below. The control device executes the air-fuel ratio feedback control in the usual operation state of the engine 10 (when the main feedback control condition is fulfilled). Thus, the control device applies the air-fuel ratio detection voltage Vp between the exhaust-side electrode layer 672 and the atmosphere-side electrode layer 673 of the upstream-side air-fuel ratio sensor 67 and acquires the detection air-fuel ratio abyfs on the basis of the output value Vabyfs of the upstream-side air-fuel ratio sensor 67. In addition, the control device controls the current condition amount of the heater 678 so that the temperature of the air-fuel ratio sensor element becomes “the target temperature (for example, 700° C.) during operation of the engine 10”. Then, the control device feedback controls the fuel amount (fuel injection amount) injected from the fuel injection valve 39, so that the detected air-fuel ratio abyfs becomes equal to the “target air-fuel ratio abyfr that has been set to the stoichiometric air-fuel ratio”. Essentially, the target air-fuel ratio abyfr may be the stoichiometric air-fuel ratio. Thus, the target air-fuel ratio abyfr may be an air-fuel ratio within a range of the so-called window of the upstream-side catalyst 53.

When the predetermined condition (determination execution condition) is fulfilled during this air-fuel ratio feedback control, the control device acquires the differential value d(abyfs)/dt of the detected air-fuel ratio abyfs and acquires an imbalance determination parameter on the basis of the differential value d(abyfs)/dt. Then, the imbalance determination parameter is compared with the imbalance determination threshold to determine whether an air-fuel ratio inter-cylinder imbalance state has occurred.

When a responsiveness indication value acquisition condition is fulfilled, the control device acquires, on the basis of the output value Vabyfs, “the responsiveness indication value corresponding to a variation rate of the output value Vabyfs of the upstream-side air-fuel ratio sensor 67” when the air-fuel ratio of the exhaust gas passing through the location in which the upstream-side air-fuel ratio sensor 67 is installed changes so as to cross the stoichiometric air-fuel ratio.

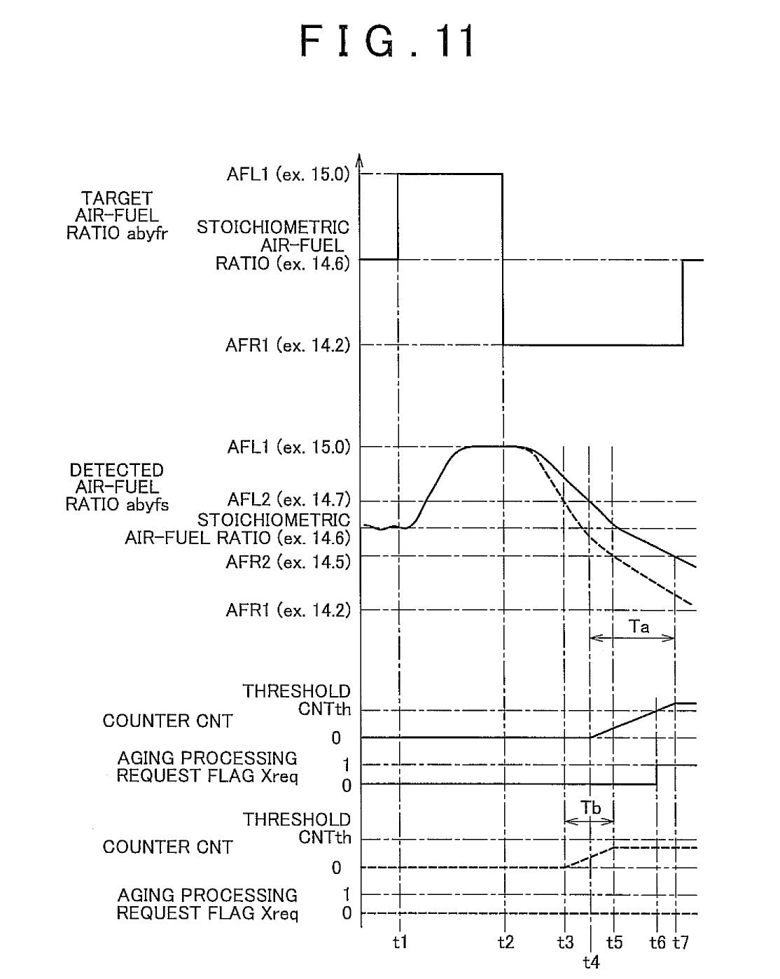

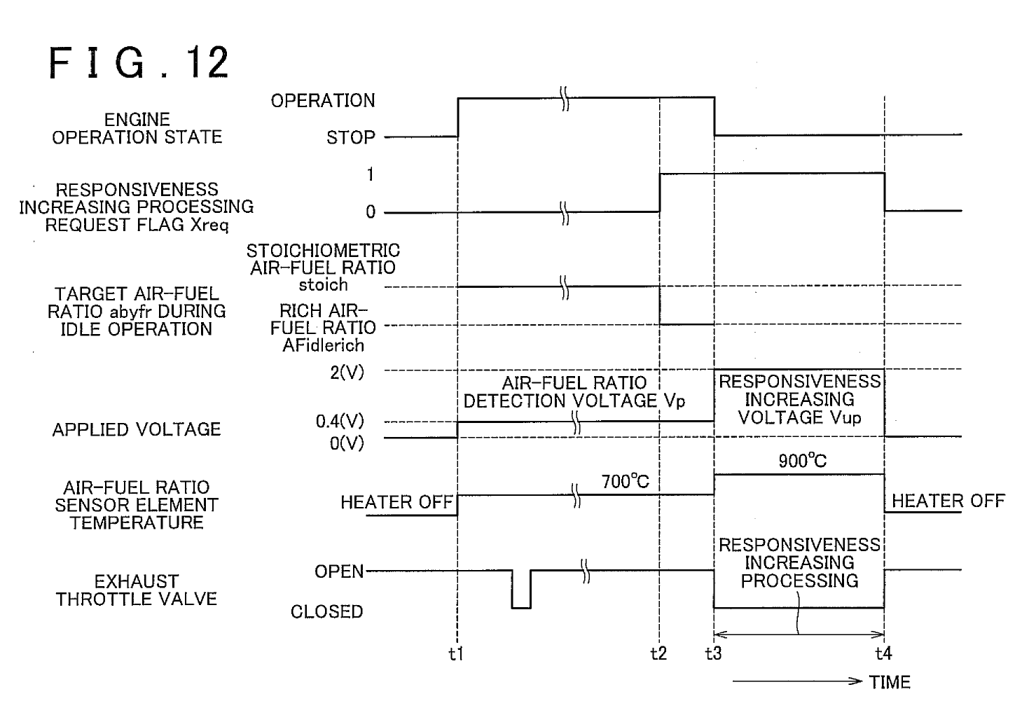

More specifically, as shown in the time chart in FIG. 11, the control device maintains the target air-fuel ratio abyfr at a first lean air-fuel ratio AFL1 over a predetermined period (see timing t1 to timing t2). The first lean air-fuel ratio AFL1 is an air-fuel ratio (for example, 15.0) greater than the stoichiometric air-fuel ratio (for example, 14.6). Then, the control device maintains the target air-fuel ratio abyfr at a first rich air-fuel ratio AFR1 (for example, 14.2) over the predetermined time interval (see after the timing t2). As a result, the air-fuel ratio of the exhaust gas passing through the location in which the upstream-side air-fuel ratio sensor 67 is installed changes rapidly from the first lean air-fuel ratio AFL1 to the first rich air-fuel ratio AFR1.

In this case, the control device acquires the time (see time Ta and time Tb) until the detected air-fuel ratio abyfs represented by the output value Vabyfs of the upstream-side air-fuel ratio sensor 67 changes from a second lean air-fuel ratio AFL2 to a second rich air-fuel ratio AFR2. This time will be referred to as the “first response time” for the sake of convenience. The second lean air-fuel ratio AFL2 is an air-fuel ratio (for example 14.7) that is greater than the stoichiometric air-fuel ratio and less than the first lean air-fuel ratio AFL1. The second rich air-fuel ratio AFR2 is an air-fuel ratio (for example 14.5) that is less than the stoichiometric air-fuel ratio and greater than the first rich air-fuel ratio AFR1.

As follows from the explanation above, the first response time is “the responsiveness indication value corresponding to a variation rate of the output value Vabyfs of the upstream-side air-fuel ratio sensor 67” when the air-fuel ratio of the exhaust gas passing through the location in which the upstream-side air-fuel ratio sensor 67 is installed changes so as to cross the stoichiometric air-fuel ratio. When the output responsiveness of the upstream-side air-fuel ratio sensor 67 is high, the first response time is a comparatively short time Tb, as shown by a broken line in FIG. 11. By contrast, when the output responsiveness of the upstream-side air-fuel ratio sensor 67 is low, the first response time is a comparatively long time Ta, as shown by a solid line in FIG. 11. Thus, the higher is the output responsiveness of the upstream-side air-fuel ratio sensor 67, the shorter is the first response time.

The control device compares the first response time (responsiveness indication value) with the predetermined threshold. When the first response time is longer than the predetermined threshold, the control device determines that the output responsiveness of the upstream-side air-fuel ratio sensor 67 is less than the allowed responsiveness.

When the output responsiveness of the upstream-side air-fuel ratio sensor 67 is determined to be less than the allowed responsiveness, the control device executes a responsiveness increasing processing for increasing the output responsiveness of the upstream-side air-fuel ratio sensor 67. The responsiveness increasing processing is also referred to as aging processing.

More specifically, as shown in the time chart in FIG. 12, when the output responsiveness of the upstream-side air-fuel ratio sensor 67 is determined to be less than the allowed responsiveness, the control device sets the value of a responsiveness increasing processing request flag to “1” (see timing t2). When the value of a responsiveness increasing processing request flag is set to “1”, the control device sets the target air-fuel ratio abyfr at the time the engine 10 is in the idle operation state to “a (rich) air-fuel ratio AFidlerich that is slightly less than the stoichiometric air-fuel ratio”.

Usually, the engine 10 is in the idle operation state immediately before the operation of the engine 10 is stopped. Therefore, when the operation of the engine 10 is stopped at the timing t3, the air-fuel ratio of exhaust gas present around the upstream-side air-fuel ratio sensor 67 is an air-fuel ratio “richer than the stoichiometric air-fuel ratio”. Thus, when the operation of the engine 10 is stopped at the timing t3, extra unburned matter is present around the upstream-side air-fuel ratio sensor 67.

Further, immediately after the operation of the engine 10 has been stopped, the control device applies a sensor responsiveness increasing voltage Vup (see timing t3 to timing t4) between the exhaust-side electrode layer 672 and the atmosphere-side electrode layer 673. At the same time, the control device controls the electric current conduction amount of the heater 678 (see timing t3 to timing t4) so that the temperature of the air-fuel ratio sensor element becomes “the responsiveness increase temperature (for example, 900° C.) that is higher than the temperature (for example, 700° C.) during the operation of the engine 10”.

When the detected air-fuel ratio abyfs thereafter becomes an air-fuel ratio larger (leaner) than the stoichiometric air-fuel ratio, the control device stops the application of voltage between the exhaust-side electrode layer 672 and the atmosphere-side electrode layer 673 and stops the conduction of current to the heater 678 (see timing t4).

As a result, immediately after the operation of the engine 10 has been stopped, (1) the sensor responsiveness increasing voltage Vup is applied between the exhaust-side electrode layer 672 and the atmosphere-side electrode layer 673 of the upstream-side air-fuel ratio sensor 67, (2) a large amount of unburned matter is present around the upstream-side air-fuel ratio sensor 67, and (3) the temperature of the air-fuel ratio sensor element of the upstream-side air-fuel ratio sensor 67 increases above the temperature of the air-fuel ratio sensor element during the operation of the engine 10. This processing will be also referred to hereinbelow as “responsiveness increasing processing”.

Therefore, oxygen of metal oxide contained in the exhaust-side electrode layer 672 becomes oxygen ions, and these oxygen ions react with the unburned matter, thereby producing water of carbon dioxide. As a result, the metal oxide contained in the exhaust-side electrode layer 672 is efficiently reduced to a metal. In addition, the state of the interface of the exhaust-side electrode layer 672, solid electrolyte layer 671, and exhaust gas changes so as to increase the reaction rate in the exhaust-side electrode layer 672. The output responsiveness of the upstream-side air-fuel ratio sensor 67 in the case in which the air-fuel ratio of exhaust gas changes in the stoichiometric air-fuel ratio region is thus increased.

When the control device determines than the output responsiveness of the upstream-side air-fuel ratio sensor 67 is equal to or higher than the allowed responsiveness, the control device maintains the value of responsiveness increasing processing request flag at “0” and does not execute the responsiveness increasing processing. Therefore, when the output responsiveness of the upstream-side air-fuel ratio sensor 67 is equal to or higher than the allowed responsiveness, the responsiveness increasing processing is not executed. Therefore, it is possible to avoid unnecessary power consumption on “application of the sensor responsiveness increasing voltage Vup and conduction to the heater 678” and accelerated deterioration of the upstream-side air-fuel ratio sensor 67.

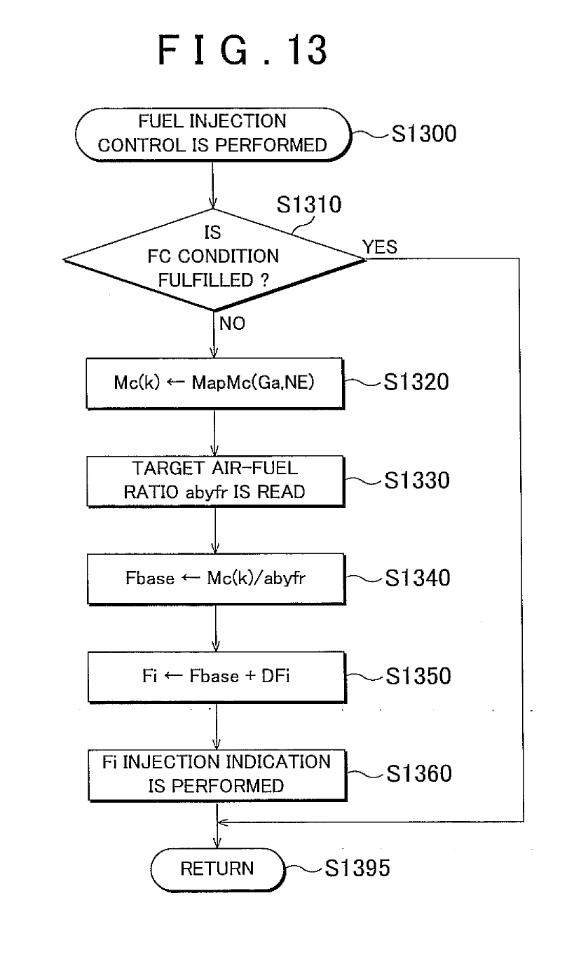

The actual operation of the CPU 81 will be explained below. The CPU 81 repeatedly executes “a routine of performing the calculation of an indicated fuel injection amount Fi and the indication of fuel injection” shown in FIG. 13 with respect to a random cylinder (will be referred to hereinbelow as a “fuel injection cylinder”) each time the crank angle of this cylinder becomes a predetermined crank angle (for example, BTDC90° CA) before the intake upper dead center. Therefore, at the predetermined timing, the CPU 81 starts the processing from step 1300 and determines in step 1310 as to whether a fuel cut condition (represented hereinbelow as “FC condition”) has been fulfilled.

Let us assume that the FC condition has not been fulfilled. In this case, the CPU 81 determines “No” in step 1310, sequentially performs the processing of the below-described steps 1320 to 1360, advances the processing to step 1395 and ends the present routine.

Step 1320: the CPU 81 acquires a “cylinder intake air amount Mc(k)”, which is “the amount of air sucked into the fuel injection cylinder” on the basis of “the intake air amount Ga measured by the air flowmeter 61, the engine revolution speed NE acquired on the basis of the signal of the crank position sensor 64, and a lookup table MapMc”. The cylinder intake air amount Mc(k) is stored in the RAM in association with each intake stroke. The cylinder intake air amount Mc(k) may be calculated by a conventional air model (a model created according to laws of physics simulating the behavior of air in the intake passage).

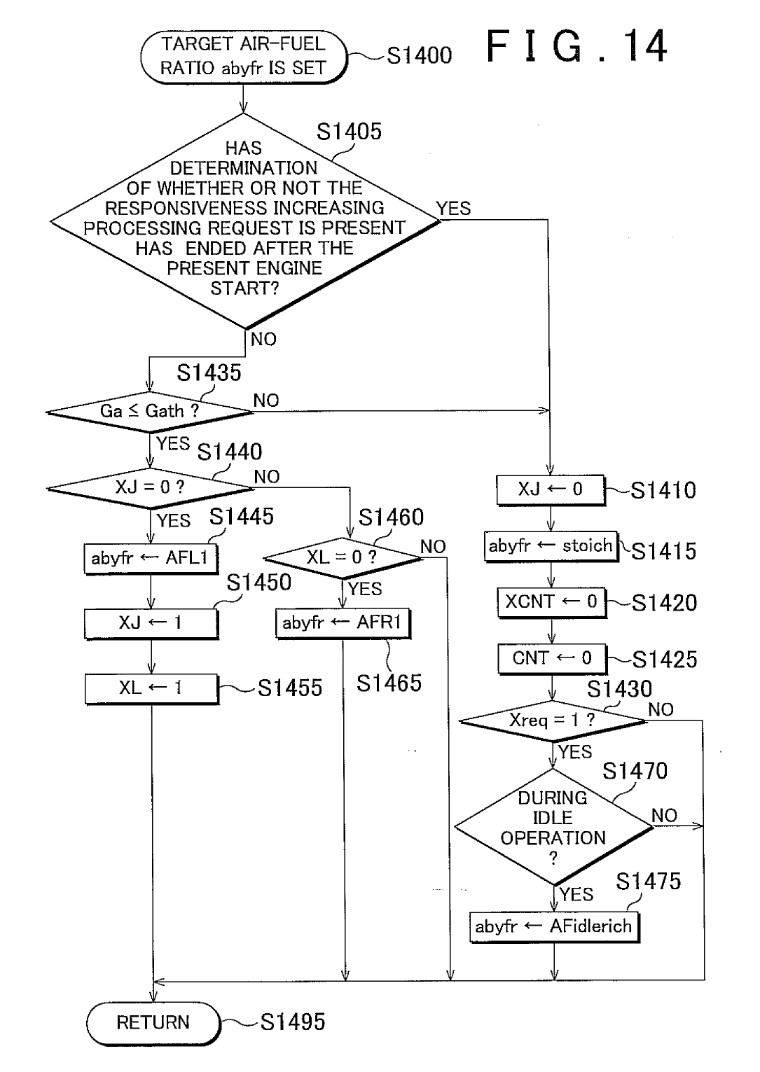

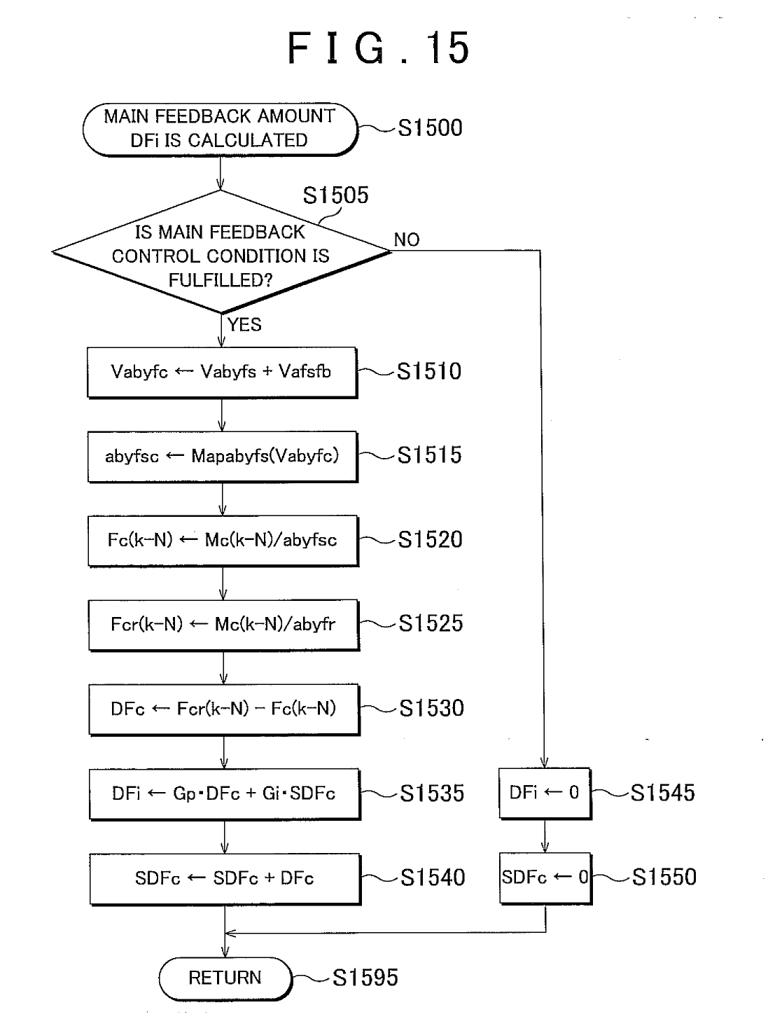

Step 1330: the CPU 81 reads the target air-fuel ratio abyfr (upstream-side the target air-fuel ratio abyfr). The target air-fuel ratio abyfr is set separately by the target air-fuel ratio setting routine shown in FIG. 14. The routine shown in FIG. 14 will be described below.

Step 1340: the CPU 81 determines a base fuel intake amount Fbase by dividing the cylinder intake air amount Mc(k) by the target air-fuel ratio abyfr. Therefore, the base fuel intake amount Fbase is a feedforward amount of fuel injection amount necessary to obtain the target air-fuel ratio abyfr.

Step 1350: the CPU 81 corrects the base fuel intake amount Fbase by a main feedback amount DFi. More specifically, the CPU 81 calculates the indicated fuel injection amount (final fuel injection amount) Fi by adding the main feedback amount DFi to the base fuel intake amount Fbase. A method for calculating the main feedback amount DFi will be described below. Step 1360: the CPU 81 injects the fuel in the indicated fuel injection amount Fi from the fuel injection valve 39 provided correspondingly to the fuel injection cylinder.

Where the FC condition is fulfilled at the point of time in which the CPU 81 executes the processing of step 1310, the CPU 81 determines “Yes” in this step 1310, advances directly to step 1395 and ends the present routine. In this case, since the fuel injection by the processing of step 1360 is not executed, the fuel cut control (fuel supply stop control) is executed.

As described above, the CPU 81 executes the target air-fuel ratio setting routine shown in FIG. 14 each time the predetermined time interval elapses. Let us now assume that “whether or not the responsiveness increasing processing request is present” has already been determined after the present start of the engine 10 and the responsiveness increasing processing request has not been issued. In this case, the value of a responsiveness increasing processing request flag Xreq (can be also referred to hereinbelow as a “request flag Xreq”) is set to “0”. The value of request flag Xreq is set to “0” in an initial routine. The initial routine is executed by the CPU 81 when the ignition key switch 71 of the vehicle where the engine 10 is installed in switched from OFF to ON.

At a predetermined timing, the CPU 81 starts the processing from step 1400 shown in FIG. 14, advances to step 1405, and determines whether or not the determination as to “whether or not the responsiveness increasing processing request is present” has ended after the present start of the engine 10.

According to the aforementioned assumptions, “whether or not the responsiveness increasing processing request is present” has already been determined after the present start of the engine 10. Therefore, the CPU 81 determines “Yes” in step 1405, sequentially performs the processing of the below-described steps 1410 to 1425, and advances the processing to step 1430.

Step 1410: The CPU 81 sets the value of flag XJ to “0”. When the value of flag XJ is “1”, the flag indicates that the processing for acquiring the responsiveness indication value has been executed. The flag XJ is set to “0” in the above-described initial routine. Step 1415: the CPU 81 sets the target air-fuel ratio abyfr to a stoichiometric air-fuel ratio stoich. Step 1420: the CPU 81 sets the value of counter execution flag XCNT to “0”. The value of counter execution flag XCNT is set to “0” in the above-described initial routine. Step 1425: the CPU 81 sets the value of counter CNT to “0”. The value of counter CNT is set to “0” in the above-described initial routine.

The CPU 81 then advances to step 1430 and determines whether or not the value of request flag Xreq is “1”. According to the aforementioned assumption, the value of request flag Xreq is “0”. Therefore, the CPU 81 determines “No” in step 1430, directly advances to step 1495, and ends the present routine. The above-described processing sets the target air-fuel ratio abyfr to the stoichiometric air-fuel ratio stoich.

The CPU 81 repeatedly executes the “main feedback amount calculation routine” shown in flowchart in FIG. 15 each time a predetermined time interval elapses. Therefore, at the predetermined timing, the CPU 81 starts the processing from step 1500, advances to step 1505, and determines whether or not “a main feedback control condition (upstream-side air-fuel ratio feedback control condition)” is fulfilled.

The main feedback control condition is fulfilled when all of the below-described conditions are fulfilled. (A1) The air-fuel ratio sensor 67 has been activated. (A2) A load (load ratio) KL of the engine is equal to or lower than a threshold KLth. (A3) The fuel cut control is not presently conducted.

The load efficiency KL is found herein from Eq. (1) shown below. The accelerator pedal operation amount Accp may be used instead of the load efficiency KL. In Eq. (1), Mc is a cylinder intake air amount, p is an air density (units: (g/L)), L is an exhaust amount of the engine 10 (units: (L)), and “4” is the number of cylinders in the engine 10.

KL=(Mc/(ρ×L/4))×100% (1)

The explanation will be continued under the assumption that the main feedback control conditions ha been fulfilled. In this case, the CPU 81 determines “Yes” in step 1505, sequentially executes the processing of the below-described steps 1510 to 1540, advances to step 1595, and ends the present routine.

Step 1510: the CPU 81 acquires the feedback control output value Vabyfc according to Eq. (2) below. In Eq. (2), Vabyfs is the output value of the air-fuel ratio sensor 67, Vafsfb is a sub-feedback amount calculated on the basis of the output value Voxs of the downstream-side air-fuel ratio sensor 68. A method for calculating the sub-feedback amount Vafsfb is available. For example, the sub-feedback amount Vafsfb is decreased when the output value Voxs of the downstream-side air-fuel ratio sensor 68 is a value indicating the air-fuel ratio on the rich side from the “downstream-side target value Voxsref that has been set to the value Vst corresponding to the stoichiometric air-fuel ratio” and increased when the output value Voxs of the downstream-side air-fuel ratio sensor 68 is a value indicating the air-fuel ratio on the lean side from the value Vst corresponding to the stoichiometric air-fuel ratio. The CPU 81 may set the sub-feedback amount Vafsfb to “0”. Thus, the CPU 81 may not execute the sub-feedback control.

Vabyfc=Vabyfs+Vafsfb (2)

Step 1515: the CPU 81 obtains the feedback control air-fuel ratio abyfsc by applying the feedback control output value Vabyfc to the table Mapabyfs shown in FIG. 4, as shown by Eq. (3) below.

abyfsc=Mapabyfs(Vabyfc) (3)

Step 1520: the CPU 81 determines a “cylinder fuel supply amount Fc(k−N)”, which is “the amount of fuel actually supplied to the combustion chamber 25 at a point of time that is N cycles before the present point of time”, as shown by Eq. (4) below. Thus, the CPU 81 determines the “cylinder fuel supply amount Fc(k−N)” by dividing a “cylinder intake air amount Mc(k−N) at a point of time that is N cycles (that is, N·720° crank angle) before the present point of time” by the aforementioned “feedback control air-fuel ratio abyfsc”.

Fc(k−N)=Mc(k−N)/abyfsc (4)

The cylinder intake air amount Mc(k−N) at the point of time that is N strokes before the present point of time is divided by the feedback control air-fuel ratio abyfsc in order to find the cylinder fuel supply amount Fc(k−N) because “a time interval corresponding to N strokes” is required for “the exhaust gas generated by combustion of the gas mixture in the combustion chamber 25” to reach the air-fuel ratio sensor 67.

Step 1525: the CPU 81 determines a “target cylinder fuel supply amount Fcr(k−N)”, which is “the amount of fuel that should be supplied to the combustion chamber 25 at a point of time that is N cycles before the present point of time”, as shown by Eq. (5) below. Thus, the CPU 81 determines the “target cylinder fuel supply amount Fcr(k−N)” by dividing a “cylinder intake air amount Mc(k−N) that is N strokes before the present point of time” by the target air-fuel ratio abyfr.

Fcr=Mc(k−N)/abyfr (5)

Step 1530: the CPU 81 acquires a cylinder fuel supply amount deviation DFc according to Eq. (6) below. Thus, the CPU 81 determines the cylinder fuel supply amount deviation DFc by subtracting the cylinder fuel supply amount Fc(k−N) from the target cylinder fuel supply amount Fcr(k−N). The cylinder fuel supply amount deviation DFc is an amount representing the degree of insufficiency of the fuel supplied to the cylinder at a point of time that is N strokes before the present point of time.

DFc=Fcr(k−N)−Fc(k−N) (6)

Step 1535: the CPU 81 determines a main feedback amount DFi according to Eq. (7) below. In Eq. (7), Gp stands for a proportional gain that has been set in advance and Gi stands for an integral gain that has been set in advance. Further, the “value SDFc” in Eq. (7) is “an integral value of the cylinder fuel supply amount deviation DFc”. In other words, the CPU 81 calculates the “main feedback amount DFi” by proportional integral control for matching the feedback control air-fuel ratio abyfsc with the target air-fuel ratio abyfr.

DFi=Gp×DFc+Gi×SDFc (7)

Step 1540: the CPU 81 acquires an integral value SDFc of a new cylinder fuel supply amount deviation by adding the cylinder fuel supply amount deviation DFc found in the above-described step 1530 to the integral value SDFc of the cylinder fuel supply amount deviation DFc at this point of time.

As described above, the main feedback amount DFi is determined by proportional integral control, and this main feedback amount DFi is reflected in the indicated fuel injection amount Fi by the processing of the above-described step 1350 illustrated by FIG. 13.

Where the main feedback control condition is determined to be unfulfilled in step 1505 shown in FIG. 15, the CPU 81 determines “No” in step 1505, advances to step 1545, and sets the value of main feedback amount DFi to “0”. Then, the CPU 81 stores “0” in the integral value SDFc of the cylinder fuel supply amount deviation in step 1550. The CPU 81 then advances to step 1595 and ends the present routine. Thus, when the main feedback control condition is unfulfilled, the main feedback amount DFi is set to “0”. Therefore, the correction of the base fuel injection amount Fbase by the main feedback amount DFi is not performed.

The operation performed by the CPU 81 when determining as to whether the responsiveness increasing processing request is present will be described below. The determination as to whether the responsiveness increasing processing request is present is performed when the “determination as to whether the responsiveness increasing processing request is present” after the present start of the engine 10 is not performed. Therefore, it is assumed that the “determination as to whether the responsiveness increasing processing request is present” after the present start of the engine 10 is not performed.

In this case, when the CPU 81 advances to step 1405 shown in FIG. 14, the CPU 81 determines “No” in step 1405, advances to step 1435, and determines whether or not the intake air amount Ga is equal to or lower than a threshold intake air amount Gath (for example, 10 g/s). In this case, where the intake air amount Ga is greater than the threshold intake air amount Gath, the CPU 81 determines “No” in step 1435 and advances to step 1410 and subsequent steps. As a result, the “determination as to whether the responsiveness increasing processing request is present” is not executed.

By contrast, where the intake air amount Ga is equal to or less than the threshold intake air amount Gath when the CPU 81 advances to step 1435 shown in FIG. 14, the CPU 81 determines “Yes” in step 1435, advances to step 1440, and starts the processing of acquiring the responsiveness indication value. Thus, the responsiveness indication value is acquired when the intake air amount Ga is equal to or less than the threshold intake air amount Gath (that is, during the low-intake air amount operation) because where the intake air amount Ga is greater than the threshold intake air amount Gath, the variation rate of the detected air-fuel ratio abyfs increases and the accurate responsiveness indication value can hardly be obtained.

The CPU 81 determines in step 1440 as to whether or not the value of flag XJ is “0”. The value of flag XJ is set by the initial routine to “0”. Therefore, the CPU 81 determines “Yes” in step 1440, successively performs the processing of the below-described steps 1445 to 1455, advances to step 1495, and ends the present routine.

Step 1445: the CPU 81 sets the target air-fuel ratio abyfr to the above-described first lean air-fuel ratio AFL1.

Step 1450: the CPU 81 sets the value of flag XJ to “1”.

Step 1455: the CPU 81 sets the value of flag XL to “1”.

The flag XL is set to “0” in the above-described initial routine. When the value of flag XL is “1”, the flag indicates that the target air-fuel ratio abyfr is set to the first lean air-fuel ratio AFL1.

As a result, since the target air-fuel ratio abyfr is set to the first lean air-fuel ratio AFL1, the air-fuel ratio of the engine is changed to the first lean air-fuel ratio AFL1 by the routine shown in FIGS. 13 to 15.

Where the CPU 81 starts the processing of the routine shown in FIG. 14 at this point of time or thereafter, the CPU 81 determines “No” in step 1405. Where the state in which the intake air amount Ga is equal to or less than the threshold intake air amount Gath is maintained, the CPU 81 determines “Yes” in step 1435 and advances to step 1440. At this point of time, the value of flag XJ is set to “1”. Therefore, the CPU 81 determines “No” in step 1440, advances to step 1460, and determines whether or not the value of flag XL is “0”. At this point of time, the value of flag XL is “1”. Therefore, the CPU 81 determines “No” in step 1460, advances directly to step 1495, and ends the present processing.

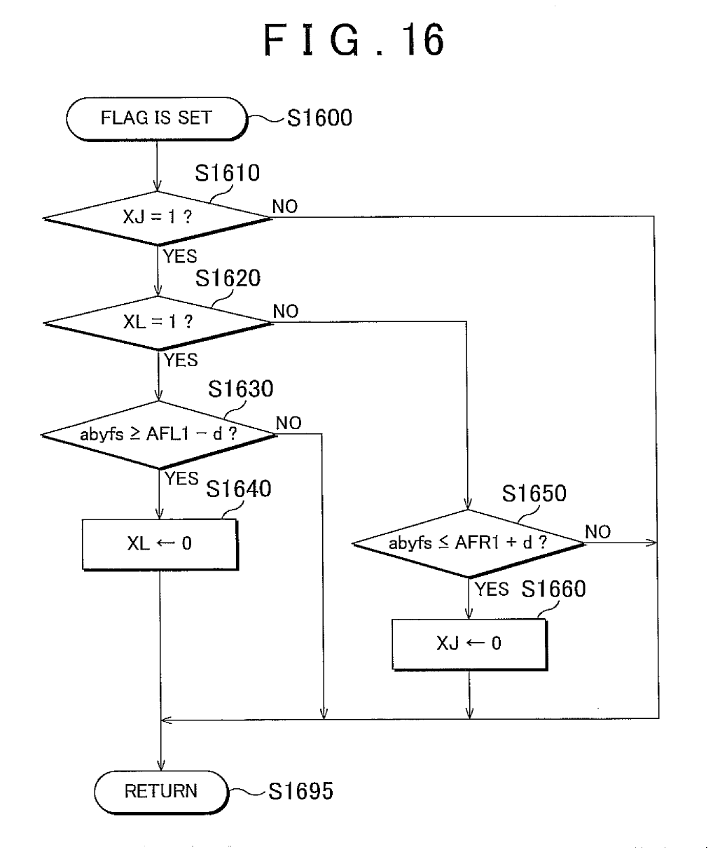

Further, the CPU 81 executes the “flag setting routine”, which is shown by the flowchart in FIG. 16, each time the predetermined time interval elapses. Therefore, at the predetermined timing, the CPU 81 starts the processing from step 1600 shown in FIG. 16, advances to step 1610, and determines whether or not the value of flag XJ is “1”. At the present point of time, the value of flag XJ is set to “1”. Therefore, the CPU 81 determines “Yes” in step 1610, advances to step 1620, and determines whether or not the value of flag XL is “1”. At the present point of time, the value of flag XL is set to “1”. Therefore, the CPU 81 determines “Yes” in step 1620, advances to step 1630 and determines whether or not the detected air-fuel ratio abyfs is equal to or greater than “the value (AFL1−d) obtained by subtracting a very small positive value d from the first lean air-fuel ratio AFL1”. Thus, in step 1630, the CPU 81 determines whether or not the output value Vabyfs of the upstream-side air-fuel ratio sensor 67 has substantially reached the value corresponding to the first lean air-fuel ratio AFL1 after the target air-fuel ratio abyfr has been set to the first lean air-fuel ratio AFL1.

Immediately after the target air-fuel ratio abyfr has been set to the first lean air-fuel ratio AFL1, the detected air-fuel ratio abyfs is less than the value (AFL1−d). Therefore, the CPU 81 determines “No” in step 1630, advances directly to step 1695, and ends the present routine.

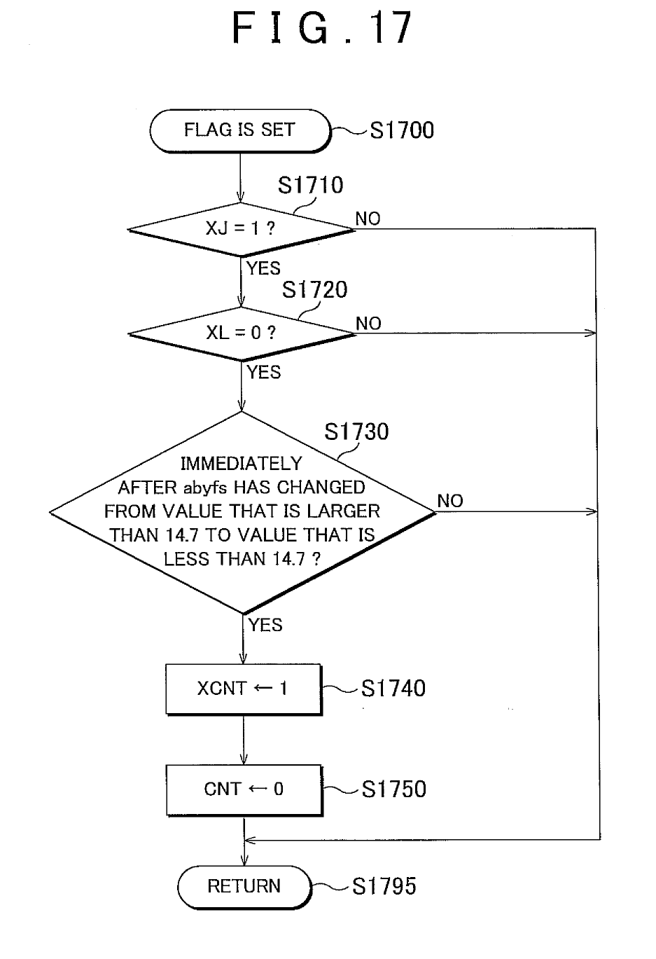

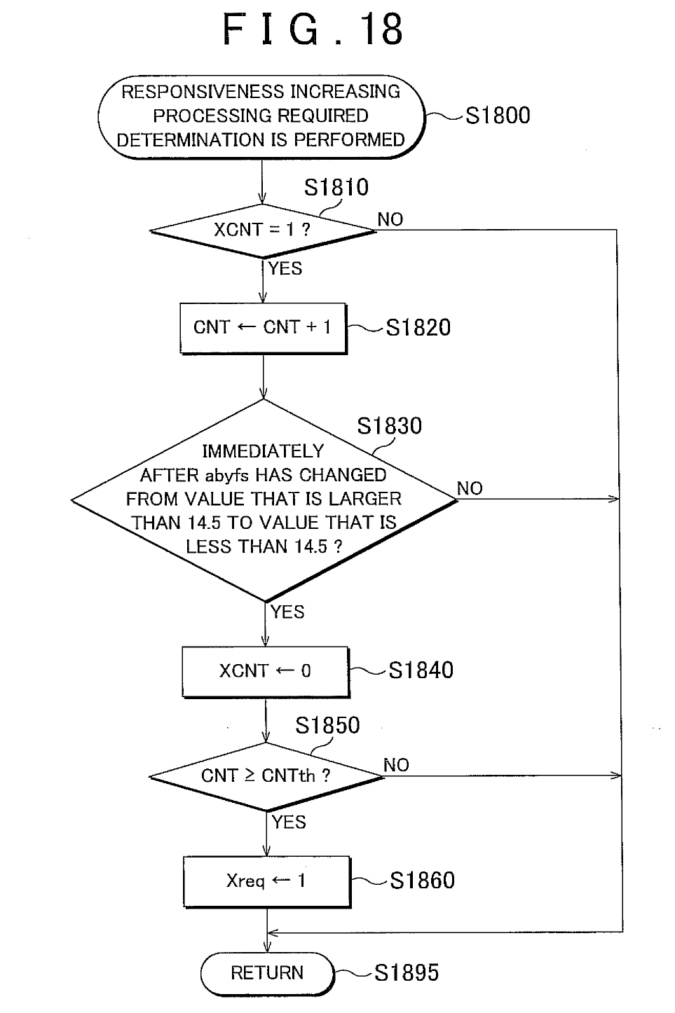

Then, the CPU 81 executes the “flag setting routine”, which is shown by a flowchart in FIG. 17, each time the predetermined time interval elapses. Therefore, at the predetermined timing, the CPU 81 starts the processing from step 1700 shown in FIG. 17, advances to step 1710, and determines whether or not the value of flag XJ is “1”. At the present point of time, the value of flag XJ is set to “1”. Therefore, the CPU 81 determines “Yes” in step 1710, advances to step 1720, and determines whether or not the value of flag XL is “0”. At the present point of time, the value of flag XL is set to “1”. Therefore, the CPU 81 determines “No” in step 1720, advances directly to step 1795, and ends the present routine.

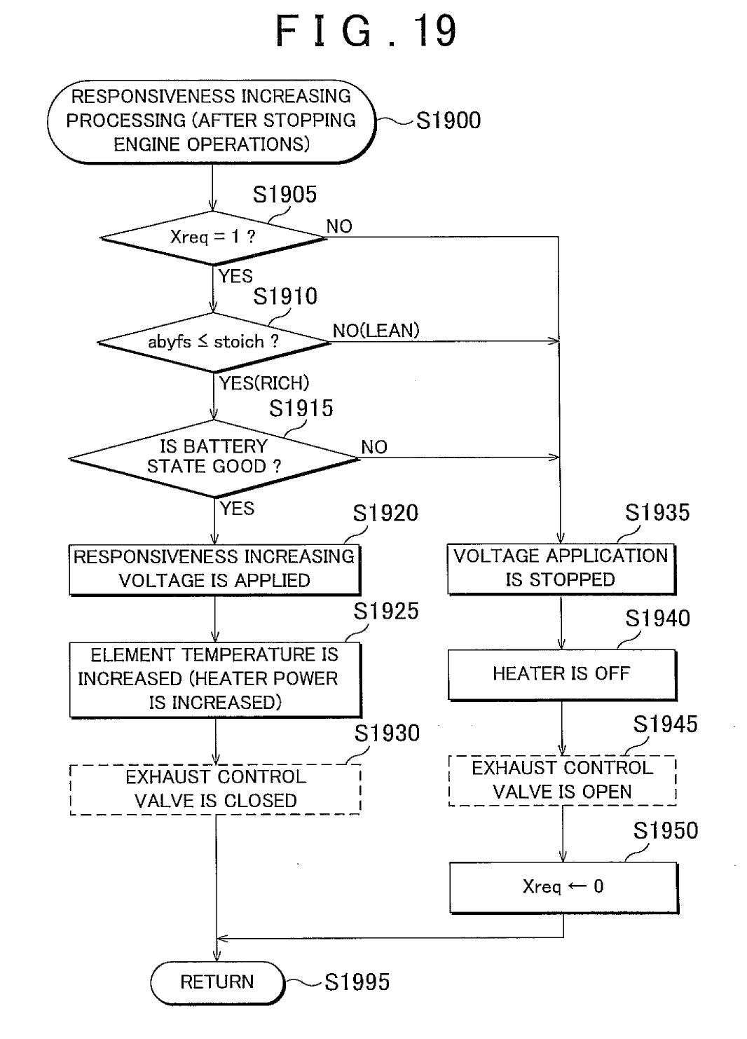

In addition, the CPU 81 executes the “responsiveness increasing processing request determination routine”, which is shown by a flowchart in FIG. 18, each time the predetermined time interval elapses. Therefore, at the predetermined timing, the CPU 81 starts the processing from step 1800 shown in FIG. 18, advances to step 1810, and determines whether or not the value of counter execution flag XCNT is “1”. At the present point of time, the value of counter execution flag XCNT is set to “0” by the above-described initial routine. Therefore, the CPU 81 determines “No” in step 1810, advances directly to step 1895, and ends the present routine.

Where this state (state in which the target air-fuel ratio abyfr is set to the first lean air-fuel ratio AFL1) is maintained, the detected air-fuel ratio abyfs reaches the value (AFL1−d). Where the CPU 81 starts the processing of the routine shown in FIG. 16 at this time, the CPU 81 determines “Yes” in step 1610 and step 1620, also determines “Yes” in step 1630, advances to step 1640, and sets the value of flag XL to “0”. Then, the CPU 81 advances to step 1695 and ends the present routine.

Where the CPU 81 starts the processing of the routine shown in FIG. 14 at this point of time or thereafter, the CPU 81 determines “No” in step 1405. Further, where the state in which the intake air-fuel ratio Ga is equal to or less than the threshold intake air amount Gath is maintained, the CPU 81 determines “Yes” in step 1435 and advances to step 1440. At this point of time, the value of flag XJ is “1”. Therefore, the CPU 81 determines “No” in step 1440 and advances to step 1460. Further, at this point of time, the value of flag XL is “0”. Therefore, the CPU 81 determines “Yes” in step 1460, advances to step 1465, and sets the target air-fuel ratio abyfr to the above-described first rich air-fuel ratio AFR1. Then, the CPU 81 advances directly to step 1495 and ends the processing.

As a result, since the target air-fuel ratio abyfr is set to the first rich air-fuel ratio AFR1, the air-fuel ratio of the engine is changed to the first lean air-fuel ratio AFR1 by the routine shown in FIGS. 13 to 15.

Where the CPU 81 starts the processing of the routine shown in FIG. 17 at this point of time or thereafter, the CPU 81 determines “Yes” in step 1710, determines “Yes” in step 1720, and advances to step 1730. Further, in step 1730, the CPU 81 determines whether or not the present point of time is immediately after the point of time in which the detected air-fuel ratio abyfs changes from a value larger than “the above-described second lean air-fuel ratio AFL2 (for example, 14.7)” to a value less than the “second lean air-fuel ratio AFL2”.

Since the present point of time is immediately after the point of time in which the detected air-fuel ratio abyfs has reached the value (AFL1−d), the detected air-fuel ratio abyfs has not reached the “second lean air-fuel ratio AFL2”. Therefore, the CPU 81 determines “No” in step 1730, advances directly to step 1795, and ends the present routine.

Where the CPU 81 then starts the processing of the routine shown in FIG. 16, the CPU 81 determines “Yes” in step 1610, determines “No” in step 1620, and advances to step 1650. Then, in step 1650, the CPU 81 determines whether or not the detected air-fuel ratio abyfs is equal to or less than “the value (AFR1+d) obtained by adding a very small positive value d to the first rich air-fuel ratio AFR1”. Thus, in step 1650, the CPU 81 determines whether or not the output value Vabyfs of the upstream-side air-fuel ratio sensor 67 has substantially reached the value corresponding to the first rich air-fuel ratio AFR1 after the target air-fuel ratio abyfr has been set to the first rich air-fuel ratio AFR1.

Since the present point of time is immediately after the point of time in which the detected air-fuel ratio abyfs has reached the value (AFL1−d), the detected air-fuel ratio abyfs has not reached the value (AFR1+d). Therefore, the CPU 81 determines “No” in step 1650, advances directly to step 1695, and ends the present routine.

Where such state is maintained, the output value Vabyfs of the upstream-side air-fuel ratio sensor 67 gradually decreases. Therefore, the detected air-fuel ratio abyfs gradually decreases. As a result, the detected air-fuel ratio abyfs changes from a value that is larger than the second lean air-fuel ratio AFL2 to a value that is less than the second lean air-fuel ratio AFL2. Therefore, where the CPU 81 starts the processing of step 1730 shown in FIG. 17 immediately after this point of time, the CPU 81 determines “Yes” in step 1730, advances to step 1740, and sets the value of counter execution flag XCNT to “1”. The CPU 81 then advances to step 1750, sets the value of counter CNT to “0”, advances to step 1795, and ends the present routine.

As a result, when the CPU 81 advances to step 1810 shown in FIG. 18, the CPU determines “Yes” in this step 1810, advances to step 1820, and increases the value of counter CNT by “1”. Thus, the counter CNT is incremented. The CPU 81 then advances to step 1830 and determines whether or not the present point of time is immediately after the point of time in which the detected air-fuel ratio abyfs changes from a value larger than “the above-described second rich air-fuel ratio AFR2 (for example, 14.5)” to a value less than the “second rich air-fuel ratio AFR2”.

The present point of time is immediately after the point of time in which the detected air-fuel ratio abyfs has reached the “second lean air-fuel ratio AFL2”. Therefore, the detected air-fuel ratio abyfs has not reached the second rich air-fuel ratio AFR2. Therefore, the CPU 81 determines “No” in step 1830, advances directly to step 1895, and ends the present routine.

Where such state is maintained, the value of counter CNT is gradually increased by the processing of step 1820. Further, the detected air-fuel ratio abyfs gradually decreases and changes from a value that is larger than the second rich air-fuel ratio AFR2 to a value that is less than the second rich air-fuel ratio AFR2. Therefore, where the CPU 81 starts the processing of step 1830 shown in FIG. 18 immediately after this point of time, the CPU 81 determines “Yes” in step 1830, advances to step 1840, and sets the value of counter execution flag XCNT to “0”. As a result, the increment of counter CNT stops. Thus, the value of counter CNT represents the time (the aforementioned first response time) required for the detected air-fuel ratio abyfs to change from the second lean air-fuel ratio AFL2 to the second rich air-fuel ratio AFR2 after the point of time in which the target air-fuel ratio abyfr has changed from the first lean air-fuel ratio AFL1 to the first rich air-fuel ratio AFR1. In other words, the value of counter CNT is a responsiveness indication value.

The CPU 81 then advances to step 1850 and determines whether or not the value of counter CNT is equal to or greater than a predetermined threshold CNTth. In this case, where the value of counter CNT is equal to or greater than the predetermined threshold CNTth, the output responsiveness of the upstream-side air-fuel ratio sensor 67 is less than the allowed responsiveness. Therefore, the CPU 81 determines “Yes” in step 1850, advances to step 1860, and sets the value of request flag Xreq to “1”. By contrast, where the value of counter CNT is less than the predetermined threshold CNTth, the output responsiveness of the upstream-side air-fuel ratio sensor 67 is equal to or higher than the allowed responsiveness. Therefore, the CPU 81 determines “No” in step 1850, advances directly to step 1895, and ends the present routine. As a result, the value of request flag Xreq is maintained at “0”. The completion of the processing of step 1850 means the completion of the determination “as to whether the responsiveness increasing processing request is present”.

In this state, the target air-fuel ratio abyfr is obviously the first rich air-fuel ratio AFR1. Therefore, where the predetermined time elapses, the output value Vabyfs of the upstream-side air-fuel ratio sensor 67 substantially reaches a value corresponding to the first rich air-fuel ratio AFR1. Thus, the detected air-fuel ratio abyfs becomes equal to or less than the value (AFL1+d). In this case, where the CPU 81 executes the processing of step 1650 shown in FIG. 16, the CPU 81 determines “Yes” in this step 1650, advances to step 1660, and sets the value of flag XJ to “0”.

As a result, the CPU 81 determines “No” in step 1610 shown in FIG. 16 and advances directly to step 1695. Likewise, the CPU 81 determines “No” in step 1710 shown in FIG. 17 and advances directly to step 1795.

When the CPU 81 advances to step 1405 (shown in FIG. 14) at this point of time or thereafter, since the determination “as to whether the responsiveness increasing processing request is present” has been completed, the CPU 81 determines “Yes” in step 1405, executes the processing of steps 1410 to step 1425, and advances to step 1430.

Let us now assume that the value of request flag Xreq has been set to “1” in step 1860 shown in FIG. 18. In this case, the CPU 81 determines “Yes” in step 1430, advances to step 1470, and determines whether or not the operation state of the engine 10 at the present point of time is an idle operation state. For example, the CPU 81 determines that the operation state of the engine 10 at the present point of time is an idle operation state when the throttle valve opening degree TA is “0” and the engine revolution speed NE is equal to or lower than a predetermined revolution speed.

Where the operation state at the present point of time is an idle operation state, the CPU 81 determines “Yes” in step 1470, advances to step 1475, and sets the target air-fuel ratio abyfr to “an idle-state rich air-fuel ratio AFidlerich that is slightly less (richer) than the stoichiometric air-fuel ratio stoich”. As a result, the air-fuel ratio of the engine in the idle operation state is richer than the stoichiometric air-fuel ratio. The CPU 81 then advances to step 1495 and ends the present routine. Further, where the operation state at the present point of time is an idle operation state when the CPU 81 executes the processing of step 1470, the CPU 81 determines “No” in step 1470, advances directly to step 1495, and ends the present routine. As a result, the target air-fuel ratio abyfr is maintained at the stoichiometric air-fuel ratio stoich (see step 1415).

The responsiveness increasing processing will be described below. The CPU 81 executes the “responsiveness increasing processing routine” illustrated by the flowchart shown in FIG. 19 each time a predetermined time interval elapses after the operation of the engine 10 has been stopped. Where the ignition key switch 71 is set at the OFF position, the CPU 81 determines that the operation of the engine 10 has been stopped.

At the predetermined timing after the operation of the engine 10 has been stopped, the CPU 81 starts the processing from step 1900 shown in FIG. 19, advances to step 1905, and determines whether or not the value of request flag Xreq is “1”.

Let us now assume that the value of request flag Xreq has been set to “1” in step 1860 shown in FIG. 18 since the output responsiveness of the air-fuel ratio sensor 67 is low. In this case, the CPU 81 determines “Yes” in step 1905, advances to step 1910, and determines whether or not the detected air-fuel ratio abyfs is lower (richer) than the stoichiometric air-fuel ratio stoich.

Where the value of request flag Xreq has been set to “1”, as mentioned hereinabove, the target air-fuel ratio abyfr in the idle operation state is set to the idle-state rich air-fuel ratio AFidlerich by the processing of steps 1470 and 1475 shown in FIG. 14.

When the engine 10 makes a transition from the operation state to the stop state, the engine 10 reaches the stop state via the idle operation state. Therefore, where the value of request flag Xreq has been set to “1”, the air-fuel ratio of gas present around the upstream-side air-fuel ratio sensor 67 immediately after the operation of the engine 10 has been stopped is a rich air-fuel ratio that is less than the stoichiometric air-fuel ratio.

Therefore, the CPU 81 determines “Yes” in step 1910, advances to step 1915, and determines whether or not the state of the battery installed on the vehicle is good. For example, in step 1915, the CPU 81 determines that the battery state is good when the battery voltage VB detected by the battery voltage sensor 72 is equal to or higher than a threshold voltage VBth. The CPU 81 may determine whether or not the battery state is good on the basis of the output of a battery residual capacity sensor (not shown in the figure).

Let us assume that the battery state is good. In this case, the CPU 81 determines “Yes” in step 1915, sequentially performs the processing of the below-described steps 1920 to 1930 (responsiveness increasing processing), advances to step 1995, and ends the present routine.

Step 1920: the CPU 81 applies the sensor responsiveness increasing voltage Vup between the exhaust-side electrode layer 672 and the atmosphere-side electrode layer 673 of the upstream-side air-fuel ratio sensor 67. Step 1925: the CPU 81 controls the conduction amount of the heater 678 so that the temperature of the air-fuel ratio sensor element becomes the responsiveness increasing temperature. Step 1930: when the engine 10 is provided with an exhaust control valve between the upstream-side air-fuel ratio sensor 67 and the upstream-side catalyst 53, the CPU 81 closes this exhaust control valve. As a result, as described hereinabove, the output responsiveness of the upstream-side air-fuel ratio sensor 67 is increased (restored).

Then, the CPU 81 repeatedly executes the processing of step 1910. Therefore, where the predetermined time elapses and the rich gas surrounding the upstream-side air-fuel ratio sensor 67 disappears, the CPU 81 determines “No” in step 1910, successively executes the processing of the below-described steps 1935 to 1950, advances to step 1995, and ends the present processing.

Step 1935: the CPU 81 stops the application of voltage between the exhaust-side electrode layer 672 and the atmosphere-side electrode layer 673 of the upstream-side air-fuel ratio sensor 67. Step 1940: the CPU 81 sets the conduction amount of the heater 678 to “0”. Thus, the heater 678 is turned OFF. Step 1945: when the engine 10 is provided with the exhaust control valve between the upstream-side air-fuel ratio sensor 67 and the upstream-side catalyst 53, the CPU 81 opens this exhaust control valve. Step 1950: the CPU 81 sets the value of request flag Xreq to “0”. As a result, the responsiveness increasing processing is ended.

In the case in which the value of request flag Xreq is not “1” when the CPU 81 advances to step 1905, the CPU determines “No” in step 1905 and executes the processing of steps 1935 to 1950. Further, where the battery state is not good when the CPU 81 advances to step 1915, the CPU executes the processing of steps 1935 to 1950.

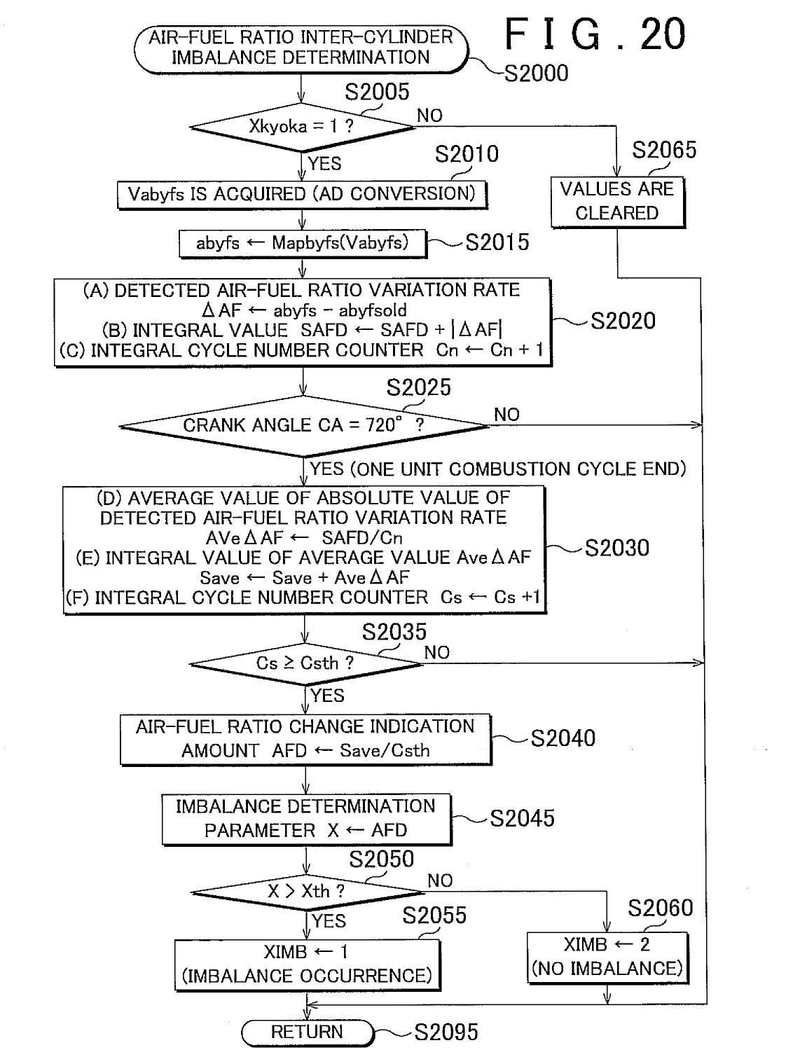

The processing for executing the “air-fuel ratio inter-cylinder imbalance determination” is explained below. The CPU 81 executes the “air-fuel ratio inter-cylinder imbalance determination routine” shown by a flowchart in FIG. 20 each time an interval of 4 ms (predetermined constant sampling time ts) elapses during the operation of the engine 10.

Therefore, at a predetermined timing, the CPU 81 starts the processing from step 2000, advances to step 2005, and determines whether or not the value of determination allowed flag Xkyoka is “1”.

The value of determination allowed flag Xkyoka is set to “1” when the below-described determination execution condition is fulfilled at a point of time in which the absolute crank angle CA becomes a 0° crank angle and is immediately set to “0” at a point of time in which the determination execution condition is not fulfilled.

The determination execution condition is fulfilled when all of the below-described conditions (conditions C0 to C3) are fulfilled. Thus, the determination execution condition is not fulfilled when at least one of the below-described conditions (conditions C0 to C3) is not fulfilled. The condition C0 and/or condition C1 may be omitted.

(Condition C0) The air-fuel ratio inter-cylinder imbalance determination has not been performed even once after the present start of the engine 10. This condition C0 will be also referred to hereinbelow as an imbalance determination implementation request condition. The condition C0 can be converted into the following condition: “the integral value of operation time of the engine 10 or the integral value of intake air amount Ga after the previous imbalance determination is equal to or higher than a predetermined value”.

(Condition C1) The state in which the intake air amount Ga acquired by the air flowmeter 61 is larger than a first threshold air flow rate Ga1th is maintained over a period equal to or longer than a first threshold time T1th. Thus, the intake air amount Ga is larger than the first threshold air flow rate Ga1th and the time that has elapsed since the point of time at which the intake air amount Ga has changed from a value that is equal to or less than the first threshold air flow rate Ga1 to a value that is greater than the first threshold air flow rate Ga1th is equal to or longer than a first threshold time T1th.

(Condition C2) The main feedback control condition is fulfilled and the target air-fuel ratio abyfr is the stoichiometric air-fuel ratio stoich. (Condition C3) The fuel cut control is not being performed.

Let us now assume that the value of determination allowed flag Xkyoka is “1”. In this case, the CPU 81 determines “Yes” in step 2005, advances to step 2010, and acquires the “output value Vabyfs of the air-fuel ratio sensor 67 at this point of time” by AD conversion.

Then, the CPU 81 advances to step 2015 and acquires the present detected air-fuel ratio abyfs by using the output value Vabyfs acquired in step 2010 in the air-fuel ratio conversion table Mapabyfs shown in FIG. 4. Prior to the processing of step 2015, the CPU 81 stores the detected air-fuel ratio abyfs acquired in the previous execution cycle of the present routine as the previous detected air-fuel ratio abyfsold. Thus, the previous detected air-fuel ratio abyfsold is the detected air-fuel ratio abyfs at a point of time that precedes the present point of time by 4 ms (sampling time ts). The initial value of the previous detected air-fuel ratio abyfsold is set to a value corresponding to the AD conversion value of the stoichiometric air-fuel ratio equivalent value Vstoich in the above-described initial routine.

Then, the CPU 81 advances to step 2020,

(A) acquires a detected air-fuel ratio variation ratio ΔAF,

(B) updates an integral value SAFD of an absolute value |ΔAF| of the detected air-fuel ratio variation ratio ΔAF, and

(C) updates an integral cycle counter Cn of the absolute value |ΔAF| of the detected air-fuel ratio variation ratio ΔAF to the integral value SAFD.

The update methods will be described below in greater detail.

(A) Acquisition of Detected Air-Fuel Ratio Variation Ratio ΔAF

The detected air-fuel ratio variation ratio ΔAF is data (basis indication amount) serving as original data of imbalance determination parameter. The CPU 81 acquires the detected air-fuel ratio variation ratio ΔAF by subtracting the previous detected air-fuel ratio abyfsold from the present detected air-fuel ratio abyfs. Thus, where the present detected air-fuel ratio abyfs is denoted by abyfs(n) and the previous detected air-fuel ratio abyfsold is denoted by abyfs(n−1), the CPU 81 determines the “present detected air-fuel ratio variation ratio ΔAF(n)” in step 2020 by the following Eq. (8). The detected air-fuel ratio variation ratio ΔAF is a value corresponding to a differential value d(abyfs)/dt of the detected air-fuel ratio abyfs.

ΔAF(n)=abyfs(n)−abyfs(n−1) (8)

(B) Update of the Integral Value SAFD of the Absolute Value |ΔAF| of the Detected Air-Fuel Ratio Variation Ratio ΔAF

The CPU 81 determines the present integral value SAFD(n) from the following Eq. (9). Thus, the CPU 81 updates the integral value SAFD by adding the absolute value |ΔAF(n)| of the abovementioned calculated present detected air-fuel ratio variation ratio ΔAF(n) to the previous integral value SAFD(n−1) at the point of time in which the transition to step 2020 has been made.

SAFD(n)=SAFD(n−1)+|ΔAF(n)| (9)

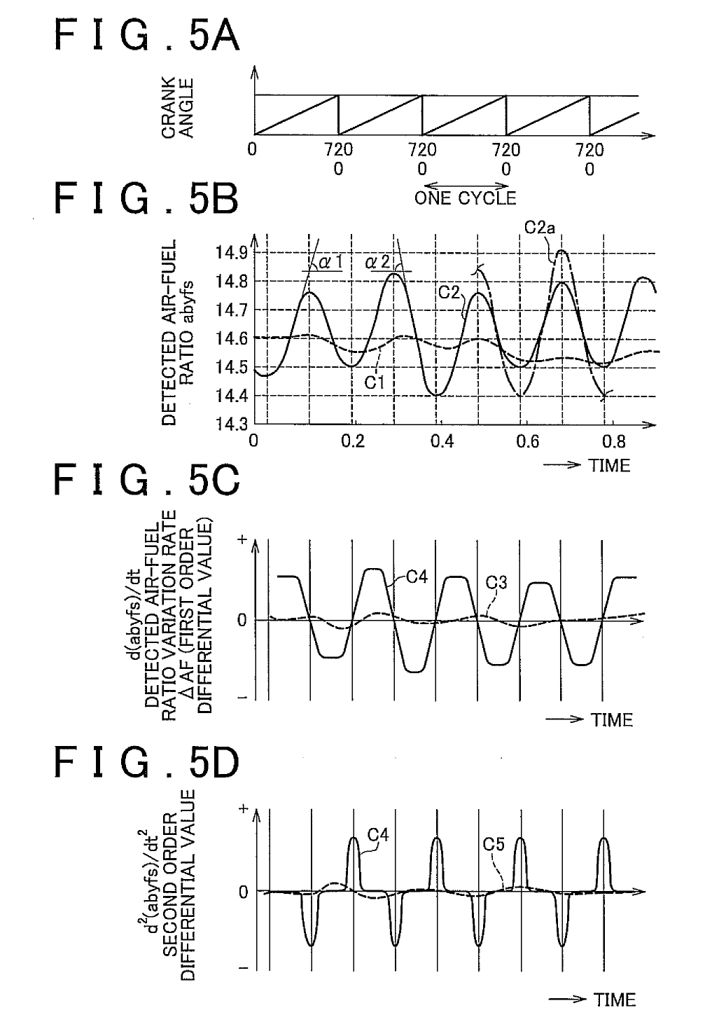

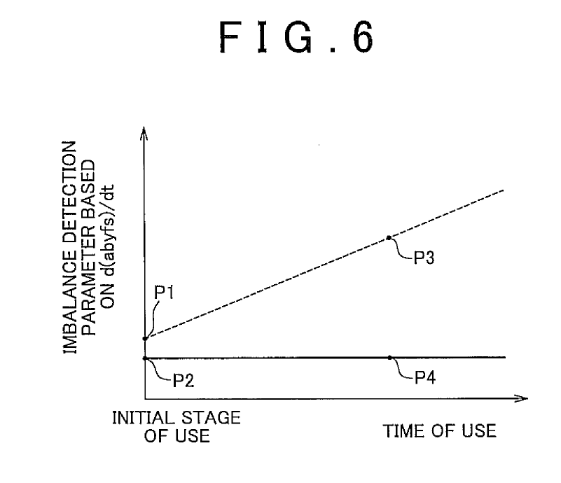

The “absolute value |ΔAF(n)| of the present detected air-fuel ratio variation ratio” is added to the integral value SAFD because the detected air-fuel ratio variation ratio ΔAF(n) can be a positive value or a negative value, as also clearly follows from FIGS. 5B and 5C. The integral value SAFD is set to “0” in the initial routine.

(C) Update of the Integral Cycle Counter Cn of the Absolute Value |ΔAF| of the Detected Air-Fuel Ratio Variation Ratio ΔAF to the Integral Value SAFD

The CPU 81 increases the value of counter Cn by “1” according to Eq. (10) below. Cn(n) is the updated counter Cn, and Cn(n−1) is the counter Cn prior to the update. The value of counter Cn is set to “0” in the above-described initial routine and also set to “0” in the below-described step 2065. Therefore, the value of counter Cn indicates a data number of the absolute value |ΔAF| of the detected air-fuel ratio variation ratio ΔAF integrated with the integral value SAFD.

Cn(n)=Cn(n−1)+1 (10)

The CPU 81 then advances to step 2025 and determines whether or not the crank angle CA (absolute crank angle CA) that is referred to the compression upper dead center of the reference cylinder (the first cylinder in the example) is a 720° crank angle. In this case, where the absolute crank angle CA is less than the 720° crank angle, the CPU 81 determines “No” in step 2025, directly advances to step 2095, and ends the present routine.

Step 2025 serves to determine a minimum unit period (unit combustion cycle period) for finding an average value of the absolute value |ΔAF| of the detected air-fuel ratio variation ratio ΔAF. Here, the 720° crank angle corresponds to the minimum period. It goes without saying that the minimum period may be shorter than the 720° crank angle, but it is preferred that the minimum period be equal to or longer than multiples of the sampling time ts. Thus, it is preferred that the minimum unit period be set so that a plurality of detected air-fuel ratio variation ratios ΔAF be acquired within the minimum unit period.

Where the absolute crank angle CA becomes the 720° crank angle at a point of time in which the CPU 81 performs the processing of step 2025, the CPU 81 determines “Yes” in this step 2025 and advances to step 2030.

In step 2030, the CPU 81: (D) calculates the average value Ave ΔAF of the absolute value |ΔAF| of the detected air-fuel ratio variation ratio ΔAF, (E) updates the integral value Save of the average value AveΔAF, and (F) updates the integral cyclic counter Cs. The update methods will be described below in greater detail.

(D) Calculation of the Average Value AveΔAF of the Absolute Value |ΔAF| of the Detected Air-Fuel Ratio Variation Ratio ΔAF

The CPU 81 calculates the average value AveΔAF (=SAFD/Cn) of the absolute value |ΔAF| of the detected air-fuel ratio variation ratio ΔAF by dividing the integral value SAFD by the value of counter Cn. Then, the CPU 81 sets the integral value SAFD to “0” and sets the value of counter Cn to “0”.

(E) Update of the Integral Value Save of the Average Value AveΔAF.

The CPU 81 determines the present integral value Save(n) from Eq. (11) below. Thus, the CPU 81 updates the integral value Save by adding the present average value AveΔAF to the previous integral value Save (n−1) at a point of time at which the transition to step 2030 was made. The value of the integral value Save is set to “0” in the above-described initial routine.

Save(n)=Save(n−1)+AveΔAF (11)

(F) Update of Integral Cyclic Counter Cs

The CPU 81 increases the value of counter Cs by “1” according to Eq. (12) below.

Cs(n) is the updated counter Cs, and Cs(n−1) is the counter Cs prior to the update. The value of counter Cs is set to “0” in the above-described initial routine. Therefore, the value of counter Cs indicates a data number of the average value AveΔAF integrated with the integral value Save.

Cs(n)=Cs(n−1)+1 (12)

The CPU 81 then advances to step 2035 and determines whether or not the value of counter Cs is equal to or higher than the threshold Csth. In this case, where the value of counter Cs is less than the threshold Csth, the CPU 81 determines “No” in this step 2035, directly advances to step 2095, and ends the present routine. The threshold Csth is a natural number and preferably equal to or higher than 2.

Where the value of counter Cs is equal to or higher than the threshold Csth at the point of time in which the CPU 81 performs the processing of step 2035, the CPU 81 determines “Yes” in step 2035, sequentially performs the processing of the below-described steps 2040 and 2045, and advances to step 2050.

Step 2040: the CPU 81 acquires an air-fuel ratio change indication amount AFD by dividing the integral value Save by the value of counter Cs (=Csth) according to Eq. (13) below. The air-fuel ratio change indication amount AFD is a value obtained by taking the average value of the absolute values |ΔAF| of the detected air-fuel ratio variation rate ΔAF for unit combustion cycle periods and averaging this average value with respect to a plurality (Csth sections) of unit combustion cycle periods. After acquiring the air-fuel ratio change indication amount AFD, the CPU 81 sets the integral value Save and the value of counter Cs to “0”.

AFD=Save/Csth (13)

Step 2045: the CPU 81 uses (stores) the air-fuel ratio change indication amount AFD as an imbalance determination parameter X.

The CPU 81 advances to step 2050 after step 2045 and determines whether or not the imbalance determination parameter X is larger than an imbalance determination threshold Xth.

In this case, where the imbalance determination parameter X is larger than an imbalance determination threshold Xth, the CPU 81 determines “Yes” in step 2050, advances to step 2055, and sets the value of imbalance occurrence flag XIMB to “1”. Thus, the CPU 81 determines whether the air-fuel ratio inter-cylinder imbalance state has occurred. In this case, the CPU 81 may light up an alarm lamp (not shown in the figure). The value of imbalance occurrence flag XIMB is stored in the backup RAM 84. The CPU 81 then advances to step 2095 and ends the present routine.

By contrast, where the imbalance determination parameter X is equal to or less than an imbalance determination threshold Xth at the point of time in which the CPU 81 performs the processing of step 2050, the CPU 81 determines “No” in step 2050, advances to step 2060, and sets the value of imbalance occurrence flag XIMB to “2”. Thus, it is stored in the memory that “the air-fuel ratio inter-cylinder imbalance state has been determined to occur as a result of air-fuel ratio inter-cylinder imbalance determination”. The CPU 81 then advances to step 2095 and ends the present routine. Step 2060 may be omitted.

Where the value of determination allowed flag Xkyoka is not “1” when the CPU 81 advances to step 2005, the CPU 81 determines “No” in step 2005 and advances to step 2065. In step 2065, the CPU 81 sets various values (for example, ΔAF, SAFD, and Cn) to “0” (clears) and then directly advances to step 2095 and ends the present routine.

As described hereinabove, the internal combustion engine control device according to the embodiment of the invention includes the air-fuel ratio sensor 67 that is configured to output an output value Vabyfs corresponding to “an air-fuel ratio of the exhaust gas passing through the location in which the air-fuel ratio sensor 67 is installed”, on the basis of a critical electric current Ip flowing in the solid electrolyte layer 671 when the air-fuel ratio detection voltage Vp is applied; the air-fuel ratio detection voltage application device (power source 679) that is configured to apply the air-fuel ratio detection voltage Vp; a plurality of fuel injection valves 39 that are configured to be installed correspondingly to the plurality of cylinders; the air-fuel ratio feedback control device (see step 1350 in FIG. 13 and also FIG. 15) that is configured to feedback control a fuel injection amount injected from the fuel injection valves 39 so that “the air-fuel ratio (detected air-fuel ratio abyfs) represented by the output value Vabyfs of the air-fuel ratio sensor 67 when the air-fuel ratio detection voltage is applied” matches “the target air-fuel ratio abyfr set to a stoichiometric air-fuel ratio”; the imbalance determination device (see steps 2050 to 2060 in FIG. 20) that is configured to acquire, on the basis of the output value Vabyfs of the air-fuel ratio sensor 67, the imbalance determination parameter X that increases with the increase in a change of the air-fuel ratio of the exhaust gas passing through the location in which the air-fuel ratio sensor 67 is installed within a period in which the feedback control is executed (see steps 2005 to 2045 in FIG. 20), and determine that an air-fuel ratio inter-cylinder imbalance state has occurred when the imbalance determination parameter X is greater than the predetermined imbalance determination threshold Xth; the responsiveness determination device that is configured to acquire, on the basis of the output value Vabyfs of the air-fuel ratio sensor 67, “a responsiveness indication value CNT corresponding to a variation rate of the output value of the air-fuel ratio sensor” when “the air-fuel ratio of the exhaust gas passing through the location in which the air-fuel ratio sensor 67 is installed” changes so as to cross the stoichiometric air-fuel ratio (see steps 1440 to 1465 of FIG. 14 and also FIGS. 16, 17, and 18) and determine whether an output responsiveness of the air-fuel ratio sensor 67 is less than the allowed responsiveness by comparing the responsiveness indication value CNT with a predetermined threshold CNTth (see step 1850 in FIG. 18); and a responsiveness increasing processing execution device (see step 1920 in shown in FIG. 19) that is configured to execute a responsiveness increasing processing for raising the output responsiveness of the air-fuel ratio sensor 67 by applying “the sensor responsiveness increasing voltage Vup that is higher than the air-fuel ratio detection voltage Vp” between the exhaust-side electrode layer 672 and the atmosphere-side electrode layer 673 so that the electric potential of the atmosphere-side electrode layer 673 becomes higher than the electric potential of the exhaust-side electrode layer 672 when the output responsiveness of the air-fuel ratio sensor is determined to be less than the allowed responsiveness (request flag Xreq=1).

Therefore, since the output responsiveness of the air-fuel ratio sensor 67 is increased by the responsiveness increasing processing, the imbalance determination parameter X assumes a value representing with good accuracy the “degree of the air-fuel ratio inter-cylinder imbalance state”.

Furthermore, the responsiveness increasing processing is executed when the output responsiveness of the air-fuel ratio sensor 67 is less than the allowed responsiveness and is not executed when the output responsiveness of the air-fuel ratio sensor 67 is equal to or higher than the allowed responsiveness. As a result, it is possible to avoid unnecessary power consumption and/or deterioration of the air-fuel ratio sensor 67.

Further, the responsiveness increasing processing is executed after the operation of the engine 10 has been stopped (see the execution timing of the routine shown in FIG. 19).

In addition, the control device controls the fuel injection amount that is injected from the fuel injection valves 39 before the operation of the engine 10 is stopped so that “the air-fuel ratio of the exhaust gas present around the air-fuel ratio sensor 67 after the operation of the engine 10 has been stopped” becomes “the air-fuel ratio less than the stoichiometric air-fuel ratio” when it is necessary to perform the responsiveness increasing processing (see steps 1430, 1470, and 1475 in FIG. 14 and also step 1340 in FIG. 13). Therefore, the output responsiveness of the air-fuel ratio sensor 67 can be increased more efficiently.

The control device controls “the air-fuel ratio of the exhaust gas present around the air-fuel ratio sensor 67 after the operation of the engine 10 has been stopped” to “the air-fuel ratio less than the stoichiometric air-fuel ratio” by setting the target air-fuel ratio abyfr during idle operation to the air-fuel ratio AFidlerich. Instead, the control device may control “the air-fuel ratio of the exhaust gas present around the air-fuel ratio sensor 67 after the operation of the engine 10 has been stopped” to “the air-fuel ratio less than the stoichiometric air-fuel ratio” by setting the downstream-side target value Voxsref used when calculating the sub-feedback amount to a value (value larger than the value Vst) corresponding to the air-fuel ratio that is slightly richer than the stoichiometric air-fuel ratio.

Further, the control device is configured to supply power to the heater 678 such that the temperature (air-fuel ratio sensor element temperature) of the solid electrolyte layer 671 after the engine 10 has been stopped becomes higher than the temperature of the solid electrolyte layer 671 during the operation of the engine 10 when it is necessary to perform the responsiveness increasing processing (see step 1925 of FIG. 19). Therefore, the output responsiveness of the air-fuel ratio sensor 67 can be increased more efficiently.

The processing of steps 1925 to 1930 in FIG. 19 can be omitted. Thus, the responsiveness increasing processing may include only the application of “the sensor responsiveness increasing voltage Vup that is higher than the air-fuel ratio detection voltage” between the exhaust-side electrode layer 672 and the atmosphere-side electrode layer 673. Further, it is also possible that the control device does not control the “air-fuel ratio of the exhaust gas present around the air-fuel ratio sensor 67 after the operation of the engine 10 has been stopped” to “the air-fuel ratio less than the stoichiometric air-fuel ratio”. Thus, the output responsiveness of the air-fuel ratio sensor 67 can be improved only by applying “the sensor responsiveness increasing voltage Vup that is higher than the air-fuel ratio detection voltage Vp” between the exhaust-side electrode layer 672 and the atmosphere-side electrode layer 673.

Further, the control device acquires as the responsiveness indication value a value CNT based on a time (first response time) until the detected air-fuel ratio abyfs represented by the output value Vabyfs of the air-fuel ratio sensor 67″ changes from the second lean air-fuel ratio AFL2, which is higher than the stoichiometric air-fuel ratio and lower than the first lean air-fuel ratio AFL1, which is higher than the stoichiometric air-fuel ratio”, to the second rich air-fuel ratio AFR2, which is lower than the stoichiometric air-fuel ratio and higher than the first rich air-fuel ratio AFR1, which is lower than the stoichiometric air-fuel ratio”, in the case in which the air-fuel ratio of the exhaust gas passing through the location in which the air-fuel ratio sensor 67 is installed” changes from the “first lean air-fuel ratio AFL1” to the first rich air-fuel ratio AFR1″.

Instead of the above-described feature or in addition thereto, the control device may acquire as the responsiveness indication value a value based on a time (second response time) until the detected air-fuel ratio abyfs represented by the output value Vabyfs of the air-fuel ratio sensor 67″ changes from “the fourth rich air-fuel ratio AFR4, which is lower than the stoichiometric air-fuel ratio and higher than the third rich air-fuel ratio AFR3”, which is lower than the stoichiometric air-fuel ratio” to “the fourth lean air-fuel ratio AFL4, which is higher than the stoichiometric air-fuel ratio and lower than the third lean air-fuel ratio AFL3”, which is higher than the stoichiometric air-fuel ratio” in the case in which “the air-fuel ratio of the exhaust gas passing through the location in which the air-fuel ratio sensor 67 is installed” changes from “the third rich air-fuel ratio AFR3” to “the third lean air-fuel ratio AFL3”.

In this case, the third rich air-fuel ratio AFR3 and the first rich air-fuel ratio AFR1 may be same or different. The third lean air-fuel ratio AFL3 and the first lean air-fuel ratio AFL1 may be same or different. The fourth rich air-fuel ratio AFR4 and the second rich air-fuel ratio AFR2 may be same or different. The fourth lean air-fuel ratio AFL4 and the second lean air-fuel ratio AFL2 may be same or different.

The control device may acquire as the responsiveness indication value a value obtained on the basis of the first response time and the second response time (for example, an average value of the first response time and the second response time).

The control device may also acquire as the responsiveness indication value a value correlated with “the differential value d(abyfs)/dt of the detected air-fuel ratio abyfs (or the differential value d(Vabyfs)/dt of the output value Vabyfsas)” (for example, the average value of the differential value d(Vabyfs)/dt that is acquired for each elapsed predetermined time interval in a period in which the detected air-fuel ratio abyfs changes from the second lean air-fuel ratio AFL2 to the second rich air-fuel ratio AFR2) in the case in which “the air-fuel ratio of the exhaust gas passing through the location in which the air-fuel ratio sensor 67 is installed” changes from “the first lean air-fuel ratio AFL1, which is higher than the stoichiometric air-fuel ratio,” to “the first rich air-fuel ratio AFR1, which is lower than the stoichiometric air-fuel ratio,” or in the opposite direction. Thus, the responsiveness indication value may be a value corresponding to “the variation rate of the output value Vabyfs or the detected air-fuel ratio abyfs when the output value Vabyfs of the air-fuel ratio sensor 67 crosses the value corresponding to the stoichiometric air-fuel ratio” in the case in which “the air-fuel ratio of the exhaust gas passing through the location in which the air-fuel ratio sensor 67 is installed changes so as to cross the stoichiometric air-fuel ratio”.

In addition, the control device may acquire the responsiveness indication value when executing a control (for example, deterioration indication control of the upstream-side catalyst 53) of forcibly changing the target air-fuel ratio abyfr from “the air-fuel ratio that is richer than the stoichiometric air-fuel ratio” to “the air-fuel ratio that is leaner than the stoichiometric air-fuel ratio” or in the opposite direction.

Furthermore, the control device may also alternately apply the sensor responsiveness increasing voltage Vup and the reverse sensor responsiveness increasing voltage Vuprev when it is necessary to perform the responsiveness increasing processing (that is, when the output responsiveness of the air-fuel ratio sensor 67 is determined to be less than the allowed responsiveness). The reverse sensor responsiveness increasing voltage Vuprev is a voltage of the same amplitude as the sensor responsiveness increasing voltage Vup but of reversed polarity. Thus, the control device may be also configured such that a reverse voltage (reverse sensor responsiveness increasing voltage Vuprev) that decreases the electric potential of the atmosphere-side electrode layer 673 to below the electric potential of the exhaust-side electrode layer 672 is applied between the exhaust-side electrode layer 672 and the atmosphere-side electrode layer 673 at a timing different from the timing at which the sensor responsiveness increasing voltage Vup is applied. As a result, oxides contained in the atmosphere-side electrode layer 673 can be removed and therefore the output responsiveness of the air-fuel ratio sensor 67 can be further increased.

In addition, the control device may be configured to execute the responsiveness increasing processing for each constant period after the operation of the engine 10 has been stopped.

As also clearly follows from FIGS. 5A to 5D, the air-fuel ratio change indication amount AFD (imbalance determination parameter X) may be the below-described parameter.

(P1) The air-fuel ratio change indication amount AFD may be a value corresponding to a trajectory length of the output value Vabyfs of the air-fuel ratio sensor 67 in the course of the feedback control or a trajectory length of the detected air-fuel ratio abyfs. For example, the trajectory length of the detected air-fuel ratio abyfs can be determined by acquiring the output value Vabyfs for each elapsed constant sampling time ts, converting the output value Vabyfs to the detected air-fuel ratio abyfs, and calculating the absolute value of the difference between this detected air-fuel ratio abyfs and the detected air-fuel ratio abyfs acquired before the constant sampling time ts.

It is desirable that the trajectory length be determined for each unit combustion cycle period. An average value of the trajectory lengths relating to a plurality of unit combustion cycle periods (that is, a value corresponding to the trajectory length) may be also used as the air-fuel ratio change indication amount AFD. The trajectory length of the output value Vabyfs and the trajectory length of the detected air-fuel ratio abyfs tend to increase with the increase in the engine revolution speed NE. Therefore, when the imbalance determination parameter based on the trajectory length is used for imbalance determination, it is preferred that the imbalance determination threshold Xth increase with the increase in the engine revolution speed NE.

(P2) The air-fuel ratio change indication amount AFD may be determined by taking the variation rate of the variation rate of “the detected air-fuel ratio abyfs or the output value Vabyfs of the air-fuel ratio sensor 67” (that is, the second order differential value d²(Vabyfs)/dt² or d²(abyfs)/dt² of this value with respect to time) as a base indication amount, the determined value corresponding to the base indication amount. For example, the air-fuel ratio change indication amount AFD may be the maximum value, within a unit combustion cycle period, of an absolute value of “the second order differential value d²(Vabyfs)/dt² of the output value Vabyfs of the air-fuel ratio sensor 67 with respect to time” or the maximum value, within a unit combustion cycle period, of an absolute value of “the second order differential value d²(abyfs)/dt², with respect to time, of the detected air-fuel ratio abyfs represented by the output value Vabyfs of the upstream-side air-fuel ratio sensor 67”.

For example, the variation rate of the variation rate of the detected air-fuel ratio abyfs can be acquired in the following manner:

the output value Vabyfs is acquired for each elapsed constant sampling time ts;

this output value Vabyfs is converted into the detected air-fuel ratio abyfs;

the difference between this detected air-fuel ratio abyfs and the detected air-fuel ratio abyfs acquired before the constant sampling time ts is acquired as a variation rate of the detected air-fuel ratio abyfs, and

the difference between the variation rate of this detected air-fuel ratio abyfs and the variation rate of the detected air-fuel ratio abyfs acquired before the constant sampling time ts is acquired as a variation rate of the variation rate of the detected air-fuel ratio abyfs (second order differential value d²(abyfs)/dt²).

In this case, it is possible to select “a value at which the absolute value reaches maximum” from among “the variation rates of the variation rate of the plurality of detected air-fuel ratio abyfs obtained in the unit combustion cycle period”, find the maximum value for a plurality of unit combustion cycle periods, and use the average value thereof as the air-fuel ratio change indication amount AFD.

Further, the above-described control devices use the differential value d(abyfs)/dt (detected air-fuel ratio variation rate ΔAF) as the base indication amount and use a value based on the average value of the base indication amount in the unit combustion cycle period as the air-fuel ratio change indication amount AFD (imbalance determination parameter X).

However, the above-described control devices may also use the differential value d(abyfs)/dt (detected air-fuel ratio variation rate ΔAF) as the base indication amount, acquire a value P1 with a maximum absolute value from among the data having positive values among the differential values d(abyfs)/dt obtained in the unit combustion cycle period, acquire a value P2 with a maximum absolute value from among the data having negative values among the differential values dVabyfs/dt obtained in the unit combustion cycle period, and use the larger of the absolute value of the value P1 and the absolute value of the value P2 as the base indication amount.

The values (imbalance determination parameter X) correlated with the “differential value d(Vabyfs)/dt, differential value d(abyfs)/dt, second order differential value d²(Vabyfs)/dt², and second order differential value d²(byfs)/dt²” are affected by the intake air amount Ga, but hardly affected by the engine revolution speed NE. This is because the flow velocity of exhaust gas inside “the outer protective cover 67b and inner protective cover 67c of the upstream-side air-fuel ratio sensor 67” changes according to the flow velocity of exhaust gas EX flowing in the vicinity of the outflow port 67b2 of the outer protective cover 67b (therefore, the intake air amount Ga which is an intake air amount per unit time). Therefore, the imbalance determination threshold that is compared with the imbalance determination parameters correlated with these values is not required to change according to the engine revolution speed NE and the necessity of such a change is extremely small.

The above-described control devices can be also applied, for example, to a V-type engine. In this case, the V-type engine can include a right-bank upstream-side catalyst disposed downstream of the exhaust collector of two or more cylinders belonging to the right bank (the catalyst installed at a position downstream of the exhaust gas collector where the exhaust gas is collected that is discharged from the combustion chambers of at least two or more cylinders from among the plurality of cylinders, this position being in the exhaust passage of the engine) and a left-bank upstream-side catalyst disposed downstream of the exhaust collector of two or more cylinders belonging to the left bank (the catalyst installed at a position downstream of the exhaust gas collector where the exhaust gas is collected that is discharged from the combustion chambers of two or more cylinders other than the at least two or more cylinders from among the plurality of cylinders, this position being in the exhaust passage of the engine).

Further, the V-type engine can include an upstream-side air-fuel ratio sensor and a downstream-side air-fuel ratio sensor for a right bank upstream and downstream of the right-bank upstream-side catalyst and also an upstream-side air-fuel ratio sensor and a downstream-side air-fuel ratio sensor for a left bank upstream and downstream of the left-bank upstream-side catalyst. Each upstream-side air-fuel ratio sensor is disposed between the exhaust collector of each bank and the upstream-side catalyst of each bank, similarly to the abovementioned air-fuel ratio sensor 67. In this case, the main feedback control and sub-feedback control for the right bank is executed, and the main feedback control and sub-feedback control for the left bank is executed independently thereof.

In this case, the control device can find “the air-fuel ratio change indication value AFD, imbalance determination parameter X, and imbalance determination threshold Xth” for the right bank on the basis of the output value of the upstream-side air-fuel ratio sensor for the right bank and can determine by using the found values as to whether or not the air-fuel ratio inter-cylinder imbalance state has occurred among the cylinders that belong to the right bank. Furthermore, when the output responsiveness of the upstream-side air-fuel ratio sensor for the right bank is less than the allowed responsiveness, the control device can execute the responsiveness increasing processing with respect to the upstream-side air-fuel ratio sensor for the right bank.

Likewise, the control device can find “the air-fuel ratio change indication value AFD, imbalance determination parameter X, and imbalance determination threshold Xth” for the left bank on the basis of the output value of the upstream-side air-fuel ratio sensor for the left bank and can determine whether or not the air-fuel ratio inter-cylinder imbalance state has occurred among the cylinders that belong to the left bank by using the found values. Furthermore, when the output responsiveness of the upstream-side air-fuel ratio sensor for the left bank is less than the allowed responsiveness, the control device can execute the responsiveness increasing processing with respect to the upstream-side air-fuel ratio sensor for the right bank.

While the invention has been described with reference to example embodiments thereof, it is to be understood that the invention is not limited to the example described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. An internal combustion engine control device comprising:
an air-fuel ratio sensor that is configured to be used in a multicylinder internal combustion engine, and configured to be installed in an exhaust collector of an exhaust passage of the engine where exhaust gas discharged from a plurality of cylinders of the engine is collected or in a location downstream of the exhaust collector of the exhaust passage, and moreover configured to include an air-fuel ratio detection unit having a solid electrolyte layer, an exhaust-side electrode layer formed on one surface of the solid electrolyte layer, a diffusion resistance layer that covers the exhaust-side electrode layer and is reached by the exhaust gas, and an atmosphere-side electrode layer that is formed on the other surface of the solid electrolyte layer and exposed inside an atmosphere chamber,
with the air-fuel ratio sensor being configured to output an output value corresponding to an air-fuel ratio of the exhaust gas passing through the location in which the air-fuel ratio sensor is installed, on the basis of a critical electric current flowing in the solid electrolyte layer when an air-fuel ratio detection voltage is applied between the exhaust-side electrode layer and the atmosphere-side electrode layer such that an electric potential of the exhaust-side electrode layer becomes higher than an electric potential of the atmosphere-side electrode layer;
an air-fuel ratio detection voltage application device that is configured to apply the air-fuel ratio detection voltage between the exhaust-side electrode layer and the atmosphere-side electrode layer;
a plurality of fuel injection valves that are configured to be installed correspondingly to the plurality of cylinders;
an air-fuel ratio feedback control device that is configured to feedback control a fuel injection amount injected from the fuel injection valves so that an air-fuel ratio represented by the output value of the air-fuel ratio sensor when the air-fuel ratio detection voltage is applied between the exhaust-side electrode layer and the atmosphere-side electrode layer matches a target air-fuel ratio set to a stoichiometric air-fuel ratio;
an imbalance determination device that is configured to acquire, on the basis of the output value of the air-fuel ratio sensor, an imbalance determination parameter that increases with the increase in a change of the air-fuel ratio of the exhaust gas passing through the location in which the air-fuel ratio sensor is installed within a period in which the feedback control is executed, and determine that an air-fuel ratio inter-cylinder imbalance state has occurred when the imbalance determination parameter is greater than a predetermined imbalance determination threshold;
a responsiveness determination device that is configured to acquire, on the basis of the output value of the air-fuel ratio sensor, a responsiveness indication value corresponding to a variation rate of the output value of the air-fuel ratio sensor when the air-fuel ratio of the exhaust gas passing through the location in which the air-fuel ratio sensor is installed changes so as to cross the stoichiometric air-fuel ratio, and determine whether an output responsiveness of the air-fuel ratio sensor is less than an allowed responsiveness by comparing the responsiveness indication value with a predetermined threshold; and
a responsiveness increasing processing execution device that is configured to execute a responsiveness increasing processing for raising the output responsiveness of the air-fuel ratio sensor by applying a sensor responsiveness increasing voltage that is higher than the air-fuel ratio detection voltage between the exhaust-side electrode layer and the atmosphere-side electrode layer so that the electric potential of the atmosphere-side electrode layer becomes higher than the electric potential of the exhaust-side electrode layer when the output responsiveness of the air-fuel ratio sensor is determined by the responsiveness determination device to be less than the allowed responsiveness.

2. The internal combustion engine control device according to claim 1, wherein the responsiveness determination device acquires at least either of: a time until the air-fuel ratio represented by the output value of the air-fuel ratio sensor changes from a second lean air-fuel ratio, which is higher than the stoichiometric air-fuel ratio and lower than a first lean air-fuel ratio, which is higher than the stoichiometric air-fuel ratio, to a second rich air-fuel ratio, which is lower than the stoichiometric air-fuel ratio and higher than a first rich air-fuel ratio, which is lower than the stoichiometric air-fuel ratio, in a case in which the air-fuel ratio of the exhaust gas passing through the location in which the air-fuel ratio sensor is installed changes from the first lean air-fuel ratio to the first rich air-fuel ratio; and a time until the air-fuel ratio represented by the output value of the air-fuel ratio sensor changes from a fourth rich air-fuel ratio, which is lower than the stoichiometric air-fuel ratio and higher than a third rich air-fuel ratio, which is lower than the stoichiometric air-fuel ratio, to a fourth lean air-fuel ratio, which is higher than the stoichiometric air-fuel ratio and lower than a third lean air-fuel ratio, which is higher than the stoichiometric air-fuel ratio, in a case in which the air-fuel ratio of the exhaust gas passing through the location in which the air-fuel ratio sensor is installed changes from the third rich air-fuel ratio to the third lean air-fuel ratio, and, on the basis of at least one acquired time, acquires the responsiveness indication value.

3. The internal combustion engine control device according to claim 2, wherein the responsiveness increasing processing execution device executes the responsiveness increasing processing after stopping engine operation.

4. The internal combustion engine control device according to claim 1, wherein the responsiveness increasing processing execution device executes the responsiveness increasing processing after stopping engine operation.

5. The internal combustion engine control device according to claim 4, wherein the responsiveness increasing processing execution device controls the fuel injection amount injected from the fuel injection valves before stopping engine operation so that the air-fuel ratio of the exhaust gas present in the location in which the air-fuel ratio sensor is installed becomes less than the stoichiometric air-fuel ratio after stopping engine operation.

6. The internal combustion engine control device according to claim 4, wherein the air-fuel ratio sensor comprises a heater that heats the solid electrolyte layer, and the responsiveness increasing processing execution device supplies electric power to the heater so that temperature of the solid electrolyte layer after the engine has been stopped becomes higher than temperature of the solid electrolyte layer while the engine is operated.

7. The internal combustion engine control device according to claim 1, wherein the responsiveness increasing processing execution device applies, at a timing different from a timing at which the sensor responsiveness increasing voltage is applied, a reverse voltage that reduces the electric potential of the atmosphere-side electrode layer below the electric potential of the exhaust-side electrode layer between the exhaust-side electrode layer and the atmosphere-side electrode layer when the output responsiveness of the air-fuel ratio sensor is determined by the responsiveness determination device to be less than the allowed responsiveness.

8. The internal combustion engine control device according to claim 1, wherein the imbalance determination device acquires a differential value of the output value of the air-fuel ratio sensor with respect to time and acquires a value correlated with the acquired differential value as the imbalance determination parameter.

9. The internal combustion engine control device according to claim 1, wherein the imbalance determination device acquires a differential value of a detected air-fuel ratio represented by the output value of the air-fuel ratio sensor with respect to time and acquires a value correlated with the acquired differential value as the imbalance determination parameter.

10. The internal combustion engine control device according to claim 1, wherein the imbalance determination device acquires a second order differential value of the output value of the air-fuel ratio sensor with respect to time and acquires a value correlated with the acquired second order differential value as the imbalance determination parameter.

11. The internal combustion engine control device according to claim 1, wherein the imbalance determination device acquires a second order differential value of a detected air-fuel ratio represented by the output value of the air-fuel ratio sensor with respect to time and acquires a value correlated with the acquired second order differential value as the imbalance determination parameter.

12. The internal combustion engine control device according to claim 1, wherein the imbalance determination device acquires a value correlated with a trajectory length within a predetermined period for the output value of the air-fuel ratio sensor as the imbalance determination parameter.

13. The internal combustion engine control device according to claim 1, wherein the imbalance determination device acquires a value correlated with a trajectory length within a predetermined period for a detected air-fuel ratio represented by the output value of the air-fuel ratio sensor as the imbalance determination parameter.

14. An internal combustion engine control method, wherein the internal combustion engine includes:
an air-fuel ratio sensor that is configured to be used in a multicylinder internal combustion engine, and configured to be installed in an exhaust collector of an exhaust passage of the engine where exhaust gas discharged from a plurality of cylinders of the engine is collected or in a location downstream of the exhaust collector of the exhaust passage, and moreover configured to include an air-fuel ratio detection unit having a solid electrolyte layer, an exhaust-side electrode layer formed on one surface of the solid electrolyte layer, a diffusion resistance layer that covers the exhaust-side electrode layer and is reached by the exhaust gas, and an atmosphere-side electrode layer that is formed on the other surface of the solid electrolyte layer and exposed inside an atmosphere chamber,
with the air-fuel ratio sensor being configured to output an output value corresponding to an air-fuel ratio of the exhaust gas passing through the location in which the air-fuel ratio sensor is installed, on the basis of a critical electric current flowing in the solid electrolyte layer when an air-fuel ratio detection voltage is applied between the exhaust-side electrode layer and the atmosphere-side electrode layer such that an electric potential of the exhaust-side electrode layer becomes higher than an electric potential of the atmosphere-side electrode layer;
an air-fuel ratio detection voltage application device that is configured to apply the air-fuel ratio detection voltage between the exhaust-side electrode layer and the atmosphere-side electrode layer;
a plurality of fuel injection valves that are configured to be installed correspondingly to the plurality of cylinders; and
an air-fuel ratio feedback control device that is configured to feedback control a fuel injection amount injected from the fuel injection valves so that an air-fuel ratio represented by the output value of the air-fuel ratio sensor when the air-fuel ratio detection voltage is applied between the exhaust-side electrode layer and the atmosphere-side electrode layer matches a target air-fuel ratio set to a stoichiometric air-fuel ratio,
the internal combustion engine control method comprising:
acquiring, on the basis of the output value of the air-fuel ratio sensor, an imbalance determination parameter that increases with an increase in a change of the air-fuel ratio of the exhaust gas passing through the location in which the air-fuel ratio sensor is installed within a period in which the feedback control is executed, and determining that an air-fuel ratio inter-cylinder imbalance state has occurred when the imbalance determination parameter is greater than a predetermined imbalance determination threshold;
acquiring, on the basis of the output value of the air-fuel ratio sensor, a responsiveness indication value corresponding to a variation rate of the output value of the air-fuel ratio sensor when the air-fuel ratio of the exhaust gas passing through the location in which the air-fuel ratio sensor is installed changes so as to cross the stoichiometric air-fuel ratio, and determining whether an output responsiveness of the air-fuel ratio sensor is less than an allowed responsiveness by comparing the responsiveness indication value with a predetermined threshold; and
executing a responsiveness increasing processing for raising the output responsiveness of the air-fuel ratio sensor by applying a sensor responsiveness increasing voltage that is higher than the air-fuel ratio detection voltage between the exhaust-side electrode layer and the atmosphere-side electrode layer so that the electric potential of the atmosphere-side electrode layer becomes higher than the electric potential of the exhaust-side electrode layer when the output responsiveness of the air-fuel ratio sensor is determined by the responsiveness determination device to be less than the allowed responsiveness.
